(19) United States
(12) Patent Application Publication
(10) Pub. No.: US 2026/0038518 A1
(43) Pub. Date: Feb. 5, 2026

(54) Scene Audio Decoding Method and Electronic Device

(71) Applicant: Huawei Technologies Co., Ltd., Shenzhen (CN)

(72) Inventors: Yuan Gao, Beijing (CN); Shuai Liu, Beijing (CN); Bingyin Xia, Beijing (CN); Zhe Wang, Beijing (CN)

(73) Assignee: Huawei Technologies Co., Ltd., Shenzhen (CN)

(21) Appl. No.: 19/355,085

(22) Filed: Oct. 10, 2025

Related U.S. Application Data
(63) Continuation of application No. PCT/CN2024/071725, filed on Jan. 11, 2024.

(30) Foreign Application Priority Data
Apr. 13, 2023 (CN) 202310428890.5

(51) Int. Cl. G10L 19/008; H04S 7/00

(52) U.S. Cl. CPC G10L 19/008; H04S 7/30; H04S 2420/11

(57) ABSTRACT

A scene audio decoding method includes: receiving a bitstream; and decoding the bitstream based on a decoding scheme combination to obtain a reconstructed scene audio signal. The decoding scheme combination includes at least one of the following combinations: a combination of a first decoding scheme, a second decoding scheme, and a third decoding scheme, and a combination of the first decoding scheme and the third decoding scheme; and the first decoding scheme is decoding encoded data obtained by encoding a signal, the second decoding scheme is a spatial decoding scheme, and the third decoding scheme is a decoding scheme other than the first decoding scheme and the second decoding scheme.

### CROSS-REFERENCE TO RELATED APPLICATIONS

This is a continuation of International Patent Application No. PCT/CN2024/071725 filed on Jan. 11, 2024, which claims priority to Chinese Patent Application No. 202310428890.5 filed on Apr. 13, 2023, both of which are incorporated by reference.

### TECHNICAL FIELD

Embodiments of the present disclosure relate to the audio encoding and decoding field, and in particular, to a scene audio decoding method and an electronic device.

### BACKGROUND

A three-dimensional audio technology is an audio technology for obtaining, processing, transmitting, rendering, and playing back sound events and three-dimensional sound field information in the real world through a computer, signal processing, or the like. Three-dimensional audio enables a sound to have a strong sense of space, envelopment, and immersion, delivering extraordinary “immersive” auditory experience. In a higher-order ambisonics (HOA) technology, recording, encoding, and playback stages are irrelevant to a speaker layout, data in a HOA format is rotatably played back. Therefore, the HOA technology has higher flexibility in playback of the three-dimensional audio, and has gained more extensive attention and research.

A channel quantity corresponding to an N-order HOA signal is (N+1)². As an HOA order quantity increases, information used to record a more detailed sound scene in an HOA signal increases accordingly. However, a data amount of the HOA signal also increases accordingly, creating challenges in both transmission and storage. Therefore, the HOA signal needs to be encoded and decoded. However, encoding performance of the HOA signal is low in the technology.

### SUMMARY

In view of this, the present disclosure provides a scene audio decoding method and an electronic device.

According to a first aspect, an embodiment of the present disclosure provides a scene audio encoding method. The method includes: obtaining a scene audio signal; and encoding the scene audio signal based on an encoding scheme combination. The encoding scheme combination includes at least one of the following combinations: a combination of a first encoding scheme, a second encoding scheme, and a third encoding scheme, and a combination of the first encoding scheme and the third encoding scheme; and the first encoding scheme is encoding a signal, the second encoding scheme is a spatial encoding scheme, and the third encoding scheme is an encoding scheme other than the first encoding scheme and the second encoding scheme.

Performing encoding based on the first encoding scheme can improve encoding quality, but requires high bit rate overheads. Performing encoding based on another encoding scheme (the second encoding scheme or the third encoding scheme) can reduce bit rate overheads, but reduces encoding quality. Therefore, performing encoding based on a combination of the first encoding scheme and the another encoding scheme in the present disclosure reduces bit rate overheads and encoding complexity while ensuring encoding quality to some extent.

For example, the scene audio signal in this embodiment of the present disclosure may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal.

For example, the scene audio signal may include an audio signal with C channels. C is a positive integer.

For example, when the scene audio signal is an HOA signal, the HOA signal may be an N-order HOA signal, namely,

$${B}_{m , n}^{σ}$$

in Formula (3) when m is truncated to an Nth item.

For example, the N-order HOA signal may include an audio signal with C channels. C=(N+1)². For example, when N=3, the N-order HOA signal includes an audio signal with 16 channels; and when N=4, the N-order HOA signal includes an audio signal with 25 channels.

For example, the first encoding scheme may also be referred to as a direct encoding scheme. To be specific, performing operations such as time-frequency transform, preprocessing, bit allocation, quantization, and entropy encoding on the signal. In this way, the signal is encoded. It should be noted that encoding the signal is encoding a to-be-encoded signal (or data). For example, when the to-be-encoded signal is a scene audio signal, encoding the scene audio signal based on the first encoding scheme may be encoding an audio signal with a part or all of channels in the scene audio signal.

For example, the scene audio signal may include one or more frames.

According to the first aspect, the spatial encoding scheme is an encoding scheme in which attribute information of a target virtual speaker is encoded, and the attribute information of the target virtual speaker is determined based on the scene audio signal.

It should be noted that a location of the target virtual speaker matches a location of a sound source in the scene audio signal; a virtual speaker signal corresponding to the target virtual speaker may be generated based on the attribute information of the target virtual speaker and an audio signal with a part of channels in the scene audio signal; and the scene audio signal may be reconstructed based on the virtual speaker signal. Therefore, an encoder side encodes the audio signal with the part of channels in the scene audio signal and the attribute information of the target virtual speaker, and then sends the encoded audio signal and the encoded attribute information to a decoder side. The decoder side may reconstruct the scene audio signal based on a reconstructed audio signal with the part of channels and the attribute information of the target virtual speaker that are obtained through decoding.

A data amount of the attribute information of the target virtual speaker is far less than a data amount of an audio signal with one channel. Therefore, compared with encoding performed based on the first encoding scheme, encoding performed based on the second encoding scheme requires fewer bit rate overheads.

The attribute information of the target virtual speaker includes at least one of the following: location information of the target virtual speaker, a location index corresponding to the location information of the target virtual speaker, or a virtual speaker index of the target virtual speaker.

For example, in a spherical coordinate system, the location information of the target virtual speaker may be, for example, (θₛ₃, φₛ₃). Herein, θₛ₃ is horizontal angle information of the target virtual speaker, and φₛ₃ is pitch angle information of the target virtual speaker.

For example, the location index is used to uniquely identify a location of a virtual speaker. The location index may include a horizontal angle index (used to uniquely identify one piece of horizontal angle information) and a pitch angle index (used to uniquely identify one piece of pitch angle information). The location index of the virtual speaker is in one-to-one correspondence with location information of the virtual speaker.

For example, the virtual speaker index may be used to uniquely identify a virtual speaker, and the location information/location index of the virtual speaker is in one-to-one correspondence with the virtual speaker index.

According to any one of the first aspect or the implementations of the first aspect, the third encoding scheme includes one or more encoding schemes.

It should be understood that types and a quantity of encoding schemes included in the third encoding scheme are not limited in the present disclosure. In this way, the third encoding scheme can be determined based on a current scene (for example, content complexity, a network bandwidth, or the like of the scene audio signal), to further improve encoding performance.

According to any one of the first aspect or the implementations of the first aspect, the third encoding scheme includes a channel copy encoding scheme. In this way, a fluctuation degree of a reconstructed scene audio signal obtained through decoding can be reduced, and audio smoothness can be improved.

According to any one of the first aspect or the implementations of the first aspect, the channel copy encoding scheme is a de-correlation encoding scheme. In this way, bit rate overheads required by the third encoding scheme are lower than bit rate overheads required by the second encoding scheme. Compared with encoding the scene audio signal based on the combination of the first encoding scheme, the second encoding scheme, and the third encoding scheme, encoding the scene audio signal based on the combination of the first encoding scheme and the third encoding scheme can reduce bit rate overheads and encoding complexity.

According to any one of the first aspect or the implementations of the first aspect, encoding the scene audio signal based on the encoding scheme combination includes: encoding one frame of scene audio signal based on a plurality of encoding schemes in the encoding scheme combination. In this way, encoding quality of each frame of scene audio signal can be improved.

According to any one of the first aspect or the implementations of the first aspect, the scene audio signal includes X frames, the X frames include an ith frame and a jth frame, and encoding the scene audio signal based on the encoding scheme combination includes: encoding the ith frame of scene audio signal based on the plurality of encoding schemes in the encoding scheme combination; and encoding the jth frame of scene audio signal based on the first encoding scheme in the encoding scheme combination. Herein, i and j are integers between 1 and X, i is unequal to j, and X is a positive integer.

In other words, a part of frames of scene audio signals is encoded based on the plurality of encoding schemes in the encoding scheme combination, and the other part of frames of scene audio signals is encoded based on the first encoding scheme in the encoding scheme combination, which can flexibly adapt to encoding in various scenes (for example, content complexity, a network bandwidth, or the like of the scene audio signal in different scenes), and improve generalization of the scene audio encoding method in the present disclosure.

According to any one of the first aspect or the implementations of the first aspect, the scene audio signal includes X frames, the X frames include an ith frame and a jth frame, and encoding the scene audio signal based on the encoding scheme combination includes: encoding the ith frame of scene audio signal based on a plurality of encoding schemes in a k1th encoding scheme combination; and encoding the jth frame of scene audio signal based on a plurality of encoding schemes in a k2th encoding scheme combination. Herein, i and j are positive integers between 1 and X, i is unequal to j, k1 and k2 are positive integers, and k1 is unequal to k2.

In other words, different frames of scene audio signals are encoded based on a plurality of encoding schemes in different encoding scheme combinations, which can flexibly adapt to encoding in various scenes (for example, content complexity, a network bandwidth, or the like of the scene audio signal in different scenes), and improve generalization of the scene audio encoding method in the present disclosure.

According to any one of the first aspect or the implementations of the first aspect, one frame of scene audio signal includes an audio signal with C channels, and when the encoding scheme combination includes the combination of the first encoding scheme, the second encoding scheme, and the third encoding scheme, encoding the one frame of scene audio signal based on the plurality of encoding schemes in the encoding scheme combination includes: for the one frame of scene audio signal, encoding C1 first channels based on the first encoding scheme, encoding C2 second channels based on the second encoding scheme, and encoding C3 third channels based on the third encoding scheme. C is equal to a sum of C1, C2, and C3, and C, C1, C2, and C3 are positive integers.

According to any one of the first aspect or the implementations of the first aspect, one frame of scene audio signal includes an audio signal with C channels, an audio signal with one channel has Y bands, and C and Y are positive integers; and encoding the one frame of scene audio signal based on the plurality of encoding schemes in the encoding scheme combination includes: encoding Y bands of one channel in the one frame of scene audio signal based on the plurality of encoding schemes in the encoding scheme combination.

For example, a frequency range of each band may be set according to a requirement. This is not limited in the present disclosure.

According to any one of the first aspect or the implementations of the first aspect, the scene audio signal is an N-order higher-order ambisonics HOA signal; the C1 first channels are C1 channels included in a 0th order to an Mth order of the N-order HOA signal, M is an integer less than N, C is equal to a square of (N+1), and C1 is less than or equal to a square of (M+1); the C2 second channels include other C4 channels included in the 0th order to the Mth order of the N-order HOA signal, and C5 channels in the N-order HOA signal other than channels included in the 0th order to the Mth order; and the C3 third channels include other C6 channels included in the 0th order to the Mth order of the N-order HOA signal, and other C7 channels in the N-order HOA signal other than channels included in the 0th order to the Mth order, where C2 is equal to a sum of C4 and C5, C3 is equal to a sum of C6 and C7, the square of (M+1) is equal to a sum of C1, C4, and C6, and C4, C5, C6, and C7 are integers.

According to any one of the first aspect or the implementations of the first aspect, encoding the C3 third channels based on the third encoding scheme includes: encoding a first preset identifier corresponding to the C3 third channels. The first preset identifier indicates that the third encoding scheme of the C3 third channels is a time-domain de-correlation encoding scheme or a frequency-domain de-correlation encoding scheme.

When the third encoding scheme is the time-domain de-correlation encoding scheme, the first preset identifier is a first preset value; or when the third encoding scheme is the frequency-domain de-correlation encoding scheme, the first preset identifier is a second preset value. In this way, the decoder side learns of whether a time-domain de-correlation decoding scheme or a frequency-domain de-correlation decoding scheme is used for the C3 third channels.

Certainly, the encoder side and the decoder side may also pre-agree on whether the time-domain de-correlation decoding scheme (the time-domain de-correlation encoding scheme) or the frequency-domain de-correlation decoding scheme (the frequency-domain de-correlation encoding scheme) is used for the C3 third channels. This is not limited in the present disclosure.

According to any one of the first aspect or the implementations of the first aspect, when the encoding scheme combination is the combination of the first encoding scheme, the second encoding scheme, and the third encoding scheme, the method further includes: encoding feature information corresponding to the C2 second channels.

For example, feature information corresponding to the C2 second channels in the scene audio signal may be determined based on information such as energy and strength of the scene audio signal. For example, the feature information is gain information.

In this way, after obtaining the feature information from a bitstream through decoding, the decoder side may compensate a reconstructed audio signal with the C2 second channels in the reconstructed scene audio signal, thereby improving audio quality of the reconstructed audio signal with the C2 second channels.

According to any one of the first aspect or the implementations of the first aspect, the method further includes: encoding a second preset identifier. The second preset identifier indicates a type of the encoding scheme combination. In this way, a decoder learns of a specific decoding scheme combination used for decoding.

Certainly, the encoder side and the decoder side may also pre-agree on the type of the encoding scheme combination. This is not limited in the present disclosure.

According to a second aspect, an embodiment of the present disclosure provides a scene audio decoding method. The decoding method includes: receiving a bitstream; and decoding the bitstream based on a decoding scheme combination, to obtain a reconstructed scene audio signal. The decoding scheme combination includes at least one of the following combinations: a combination of a first decoding scheme, a second decoding scheme, and a third decoding scheme, and a combination of the first decoding scheme and the third decoding scheme; and the first decoding scheme is decoding encoded data obtained by encoding a signal, the second decoding scheme is a spatial decoding scheme, and the third decoding scheme is a decoding scheme other than the first decoding scheme and the second decoding scheme.

Corresponding to a decoder side, in the present disclosure, decoding is performed based on a combination of the first decoding scheme and another decoding scheme, so that decoding complexity can be reduced while ensuring audio quality to some extent.

According to the second aspect, the spatial decoding scheme is a decoding scheme in which reconstruction is performed based on attribute information of a target virtual speaker, and the attribute information of the target virtual speaker is obtained by decoding the bitstream.

According to any one of the second aspect or the implementations of the second aspect, the third decoding scheme includes one or more decoding schemes.

According to any one of the second aspect or the implementations of the second aspect, the third decoding scheme includes a channel copy decoding scheme.

According to any one of the second aspect or the implementations of the second aspect, the channel copy decoding scheme is a de-correlation decoding scheme.

In this way, when the third decoding scheme is the channel copy decoding scheme, a fluctuation degree of the reconstructed scene audio signal obtained through decoding can be reduced, and audio smoothness can be improved.

According to any one of the second aspect or the implementations of the second aspect, decoding the bitstream based on the decoding scheme combination, to obtain the reconstructed scene audio signal includes: decoding one frame of bitstream based on a plurality of decoding schemes in the decoding scheme combination, to obtain one frame of reconstructed scene audio signal.

According to any one of the second aspect or the implementations of the second aspect, the bitstream includes X frames, the X frames include an ith frame and a jth frame, and decoding the bitstream based on the decoding scheme combination, to obtain the reconstructed scene audio signal includes: decoding the ith frame of bitstream based on the plurality of decoding schemes in the decoding scheme combination, to obtain an ith frame of reconstructed scene audio signal; and decoding the jth frame of bitstream based on the first decoding scheme in the decoding scheme combination, to obtain a jth frame of reconstructed scene audio signal.

Herein, i and j are integers between 1 and X, i is unequal to j, and X is a positive integer.

According to any one of the second aspect or the implementations of the second aspect, the bitstream includes X frames, the X frames include an ith frame and a jth frame, and decoding the bitstream based on the decoding scheme combination, to obtain the reconstructed scene audio signal includes: decoding the ith frame of bitstream based on a plurality of decoding schemes in a k1th decoding scheme combination, to obtain an ith frame of reconstructed scene audio signal; and decoding the jth frame of bitstream based on the plurality of decoding schemes in a k2th decoding scheme combination, to obtain a jth frame of reconstructed scene audio signal.

Herein, i and j are positive integers between 1 and X, i is unequal to j, k1 and k2 are positive integers, and k1 is unequal to k2.

According to any one of the second aspect or the implementations of the second aspect, one frame of reconstructed scene audio signal includes a reconstructed audio signal with C channels, and when the decoding scheme combination is the combination of the first decoding scheme, the second decoding scheme, and the third decoding scheme, decoding the frame of bitstream based on the plurality of decoding schemes in the decoding scheme combination, to obtain the frame of reconstructed scene audio signal includes: based on the one frame of bitstream, decoding C1 first channels based on the first decoding scheme, decoding C2 second channels based on the second decoding scheme, and decoding C3 third channels based on the third decoding scheme, to obtain the one frame of reconstructed scene audio signal.

C is equal to a sum of C1, C2, and C3, and C, C1, C2, and C3 are positive integers.

According to any one of the second aspect or the implementations of the second aspect, the one frame of reconstructed scene audio signal includes a reconstructed audio signal with C channels, a reconstructed audio signal with one channel has Y bands, and C and Y are positive integers; and decoding the one frame of bitstream based on the plurality of decoding schemes in the decoding scheme combination, to obtain the one frame of reconstructed scene audio signal includes: for Y bands of one channel in the one frame of reconstructed scene audio signal, decoding the one frame of bitstream based on the plurality of decoding schemes in the decoding scheme combination, to obtain the one frame of reconstructed scene audio signal.

According to any one of the second aspect or the implementations of the second aspect, the reconstructed scene audio signal is an N-order higher-order ambisonics HOA signal; the C1 first channels are C1 channels included in a 0th order to an Mth order of the N-order HOA signal, M is an integer less than N, C is equal to a square of (N+1), and C1 is less than or equal to a square of (M+1); the C2 second channels include other C4 channels included in the 0th order to the Mth order of the N-order HOA signal, and C5 channels in the N-order HOA signal other than channels included in the 0th order to the Mth order; and the C3 third channels include other C6 channels included in the 0th order to the Mth order of the N-order HOA signal, and other C7 channels in the N-order HOA signal other than channels included in the 0th order to the Mth order.

C2 is equal to a sum of C4 and C5, C3 is equal to a sum of C6 and C7, the square of (M+1) is equal to a sum of C1, C4, and C6, and C4, C5, C6, and C7 are integers.

According to any one of the second aspect or the implementations of the second aspect, decoding the C3 third channels based on the third decoding scheme includes: decoding the C3 third channels based on a third decoding scheme corresponding to a first preset identifier obtained by parsing the bitstream. The third decoding scheme corresponding to the first preset identifier is a time-domain de-correlation decoding scheme or a frequency-domain de-correlation decoding scheme.

According to any one of the second aspect or the implementations of the second aspect, when the decoding scheme combination is the combination of the first decoding scheme, the second decoding scheme, and the third decoding scheme, the method further includes: compensating a reconstructed audio signal with the C2 second channels in the reconstructed scene audio signal based on feature information that corresponds to the C2 second channels and that is obtained by parsing the bitstream.

According to any one of the second aspect or the implementations of the second aspect, the method further includes: parsing out a second preset identifier from the bitstream; and decoding the bitstream based on the decoding scheme combination, to obtain the reconstructed scene audio signal includes: decoding the bitstream based on a decoding scheme combination corresponding to the second preset identifier, to obtain the reconstructed scene audio signal.

Any one of the second aspect and the implementations of the second aspect corresponds to any one of the first aspect and the implementations of the first aspect. For technical effect corresponding to any one of the second aspect and the implementations of the second aspect, refer to technical effect corresponding to any one of the first aspect and the implementations of the first aspect.

According to a third aspect, an embodiment of the present disclosure provides a bitstream generation method. In the method, a bitstream may be generated according to any one of the first aspect or the implementations of the first aspect.

Any one of the third aspect and the implementations of the third aspect corresponds to any one of the first aspect and the implementations of the first aspect. For technical effect corresponding to any one of the third aspect and the implementations of the third aspect, refer to technical effect corresponding to any one of the first aspect and the implementations of the first aspect.

According to a fourth aspect, an embodiment of the present disclosure provides a scene audio encoding apparatus. The apparatus includes: a signal obtaining module configured to obtain a to-be-encoded scene audio signal; and an encoding module configured to encode the scene audio signal based on an encoding scheme combination. The encoding scheme combination includes at least one of the following combinations: a combination of a first encoding scheme, a second encoding scheme, and a third encoding scheme, and a combination of the first encoding scheme and the third encoding scheme; and the first encoding scheme is encoding a signal, the second encoding scheme is a spatial encoding scheme, and the third encoding scheme is an encoding scheme other than the first encoding scheme and the second encoding scheme.

The scene audio encoding apparatus in the fourth aspect may perform the steps in any one of the first aspect and the implementations of the first aspect.

In addition, the scene audio encoding apparatus in the fourth aspect may further include a communication module.

Any one of the fourth aspect and the implementations of the fourth aspect corresponds to any one of the first aspect and the implementations of the first aspect. For technical effect corresponding to any one of the fourth aspect and the implementations of the fourth aspect, refer to technical effect corresponding to any one of the first aspect and the implementations of the first aspect.

According to a fifth aspect, an embodiment of the present disclosure provides a scene audio decoding apparatus. The apparatus includes: a bitstream receiving module configured to receive a bitstream; and a decoding module configured to decode the bitstream based on a decoding scheme combination, to obtain a reconstructed scene audio signal.

The decoding scheme combination includes at least one of the following combinations: a combination of a first decoding scheme, a second decoding scheme, and a third decoding scheme, and a combination of the first decoding scheme and the third decoding scheme; and the first decoding scheme is decoding encoded data obtained by encoding a signal, the second decoding scheme is a spatial decoding scheme, and the third decoding scheme is a decoding scheme other than the first decoding scheme and the second decoding scheme.

The scene audio decoding apparatus in the fifth aspect may perform the steps in any one of the second aspect and the implementations of the second aspect.

In addition, the scene audio decoding apparatus in the fifth aspect may further include a communication module.

Any one of the fifth aspect and the implementations of the fifth aspect corresponds to any one of the second aspect and the implementations of the second aspect. For technical effect corresponding to any one of the fifth aspect and the implementations of the fifth aspect, refer to technical effect corresponding to any one of the second aspect and the implementations of the second aspect.

According to a sixth aspect, an embodiment of the present disclosure provides an electronic device, including a memory and a processor. The memory is coupled to the processor, the memory stores program instructions, and when the program instructions are executed by the processor, the electronic device is enabled to perform the scene audio encoding method according to any one of the first aspect or the possible implementations of the first aspect.

Any one of the sixth aspect and the implementations of the sixth aspect corresponds to any one of the first aspect and the implementations of the first aspect. For technical effect corresponding to any one of the sixth aspect and the implementations of the sixth aspect, refer to technical effect corresponding to any one of the first aspect and the implementations of the first aspect.

According to a seventh aspect, an embodiment of the present disclosure provides an electronic device, including a memory and a processor. The memory is coupled to the processor, the memory stores program instructions, and when the program instructions are executed by the processor, the electronic device is enabled to perform the scene audio decoding method according to any one of the second aspect or the possible implementations of the second aspect.

Any one of the seventh aspect and the implementations of the seventh aspect corresponds to any one of the second aspect and the implementations of the second aspect. For technical effect corresponding to any one of the seventh aspect and the implementations of the seventh aspect, refer to technical effect corresponding to any one of the second aspect and the implementations of the second aspect.

According to an eighth aspect, an embodiment of the present disclosure provides a chip, including one or more interface circuits and one or more processors. The one or more processors receive or send data through the one or more interface circuits. When the one or more processors execute computer instructions, the electronic device is enabled to perform the scene audio encoding method according to any one of the first aspect or the possible implementations of the first aspect.

Any one of the eighth aspect and the implementations of the eighth aspect corresponds to any one of the first aspect and the implementations of the first aspect. For technical effect corresponding to any one of the eighth aspect and the implementations of the eighth aspect, refer to technical effect corresponding to any one of the first aspect and the implementations of the first aspect.

According to a ninth aspect, an embodiment of the present disclosure provides a chip, including one or more interface circuits and one or more processors. The one or more processors receive or send data through the one or more interface circuits. When the one or more processors execute computer instructions, the electronic device is enabled to perform the scene audio decoding method according to any one of the second aspect or the possible implementations of the second aspect.

Any one of the ninth aspect and the implementations of the ninth aspect corresponds to any one of the second aspect and the implementations of the second aspect. For technical effect corresponding to any one of the ninth aspect and the implementations of the ninth aspect, refer to technical effect corresponding to any one of the second aspect and the implementations of the second aspect.

According to a tenth aspect, an embodiment of the present disclosure provides a computer-readable storage medium. The computer-readable storage medium stores a computer program. When the computer program is run on a computer or a processor, the computer or the processor is enabled to perform the scene audio encoding method according to any one of the first aspect or the possible implementations of the first aspect.

Any one of the tenth aspect and the implementations of the tenth aspect corresponds to any one of the first aspect and the implementations of the first aspect. For technical effect corresponding to any one of the tenth aspect and the implementations of the tenth aspect, refer to technical effect corresponding to any one of the first aspect and the implementations of the first aspect.

According to an eleventh aspect, an embodiment of the present disclosure provides a computer-readable storage medium. The computer-readable storage medium stores a computer program. When the computer program is run on a computer or a processor, the computer or the processor is enabled to perform the scene audio decoding method according to any one of the second aspect or the possible implementations of the second aspect.

Any one of the eleventh aspect and the implementations of the eleventh aspect corresponds to any one of the second aspect and the implementations of the second aspect. For technical effect corresponding to any one of the eleventh aspect and the implementations of the eleventh aspect, refer to technical effect corresponding to any one of the second aspect and the implementations of the second aspect.

According to a twelfth aspect, an embodiment of the present disclosure provides a computer program product. The computer program product includes a software program. When the software program is executed by a computer or a processor, the computer or the processor is enabled to perform the scene audio encoding method according to any one of the first aspect or the possible implementations of the first aspect.

Any one of the twelfth aspect and the implementations of the twelfth aspect corresponds to any one of the first aspect and the implementations of the first aspect. For technical effect corresponding to any one of the twelfth aspect and the implementations of the twelfth aspect, refer to technical effect corresponding to any one of the first aspect and the implementations of the first aspect.

According to a thirteenth aspect, an embodiment of the present disclosure provides a computer program product. The computer program product includes a software program. When the software program is executed by a computer or a processor, the computer or the processor is enabled to perform the scene audio decoding method according to any one of the second aspect or the possible implementations of the second aspect.

Any one of the thirteenth aspect and the implementations of the thirteenth aspect corresponds to any one of the second aspect and the implementations of the second aspect. For technical effect corresponding to any one of the thirteenth aspect and the implementations of the thirteenth aspect, refer to technical effect corresponding to any one of the second aspect and the implementations of the second aspect.

According to a fourteenth aspect, an embodiment of the present disclosure provides a bitstream storage apparatus. The apparatus includes a receiver and at least one storage medium. The receiver is configured to receive a bitstream. The at least one storage medium is configured to store the bitstream. The bitstream is generated according to any one of the first aspect and the implementations of the first aspect.

Any one of the fourteenth aspect and the implementations of the fourteenth aspect corresponds to any one of the first aspect and the implementations of the first aspect. For technical effect corresponding to any one of the fourteenth aspect and the implementations of the fourteenth aspect, refer to technical effect corresponding to any one of the first aspect and the implementations of the first aspect.

According to a fifteenth aspect, an embodiment of the present disclosure provides a bitstream transmission apparatus. The apparatus includes a transmitter and at least one storage medium. The at least one storage medium is configured to store a bitstream. The bitstream is generated according to any one of the first aspect and the implementations of the first aspect. The transmitter is configured to: receive the bitstream from the storage medium, and send the bitstream to a terminal-side device through a transmission medium.

Any one of the fifteenth aspect and the implementations of the fifteenth aspect corresponds to any one of the first aspect and the implementations of the first aspect. For technical effect corresponding to any one of the fifteenth aspect and the implementations of the fifteenth aspect, refer to technical effect corresponding to any one of the first aspect and the implementations of the first aspect.

According to sixteenth aspect, an embodiment of the present disclosure provides a bitstream distribution system. The system includes: at least one storage medium configured to store at least one bitstream, where the at least one bitstream is generated according to any one of the first aspect and the implementations of the first aspect; and a streaming media device configured to: obtain a target bitstream from the at least one storage medium, and send the target bitstream to a terminal-side device, where the streaming media device includes a content server or a content delivery server.

Any one of the sixteenth aspect and the implementations of the sixteenth aspect corresponds to any one of the first aspect and the implementations of the first aspect. For technical effect corresponding to any one of the sixteenth aspect and the implementations of the sixteenth aspect, refer to technical effect corresponding to any one of the first aspect and the implementations of the first aspect.

### BRIEF DESCRIPTION OF DRAWINGS

FIG. 1A is a diagram of an example application scenario;

FIGS. 1B-1C are diagrams of an example application scenario;

FIG. 2 is a diagram of an example scene audio signal encoding process;

FIG. 3 is a diagram of an example scene audio signal decoding process;

FIG. 4A is a diagram of an example scene audio signal encoding process;

FIG. 4B is a diagram of an example distribution of candidate virtual speakers;

FIG. 5 is a diagram of an example scene audio signal decoding process;

FIG. 6 is a diagram of an example scene audio signal encoding process;

FIG. 7 is a diagram of an example scene audio signal decoding process;

FIG. 8 is a diagram of an example scene audio signal encoding process;

FIG. 9 is a diagram of an example scene audio signal decoding process; and

FIG. 10 is a diagram of a structure of an example apparatus.

### DESCRIPTION OF EMBODIMENTS

The following clearly and completely describes the technical solutions in embodiments of the present disclosure with reference to the accompanying drawings in embodiments of the present disclosure. It is clear that the described embodiments are some but not all of embodiments of the present disclosure. All other embodiments obtained by a person of ordinary skill in the art based on embodiments of the present disclosure without creative efforts shall fall within the protection scope of the present disclosure.

The term “and/or” in this specification describes only an association relationship for describing associated objects and represents that three relationships may exist. For example, A and/or B may represent the following three cases: Only A exists, both A and B exist, and only B exists.

In the specification and claims in embodiments of the present disclosure, the terms “first”, “second”, and so on are intended to distinguish between different objects but do not indicate a particular order of the objects. For example, a first target object, a second target object, and the like are used for distinguishing between different target objects, but are not used for describing a specific order of the target objects.

In embodiments of the present disclosure, the word such as “example” or “for example” represents giving an example, an illustration, or a description. Any embodiment or design scheme described as an “example” or “for example” in embodiments of the present disclosure should not be explained as being more preferred or having more advantages than another embodiment or design scheme. To be precise, use of the word such as “example” or “for example” is intended to present a relative concept in a specific manner.

In descriptions of embodiments of the present disclosure, “a plurality of” means two or more, unless otherwise specified. For example, a plurality of processing units means two or more processing units, and a plurality of systems means two or more systems.

For clear and brief description of the following embodiments, a brief description of a related technology is first provided.

A sound is a continuous wave generated by an object through vibration. An object that vibrates to emit a sound wave is referred to as a sound source. In a process in which the sound wave is propagated through a medium (for example, air, solid, or liquid), an auditory organ of a human or an animal can sense the sound.

Features of the sound wave include a tone, intensity, and a timbre. The tone indicates a level of the sound. The intensity indicates volume of the sound. The intensity may also be referred to as loudness or volume. A unit of the intensity is decibel (dB). The timbre is also referred to as sound quality.

A frequency of the sound wave determines the level of the tone. A higher frequency indicates a higher tone. A quantity of times that the object vibrates in 1 second is referred to as a frequency, and a frequency unit is hertz (Hz). A frequency of a sound that can be recognized by a human ear is between 20 Hz and 20000 Hz.

An amplitude of the sound wave determines the intensity. A larger amplitude indicates higher intensity. A shorter distance from the sound source indicates higher intensity.

A waveform of the sound wave determines the timbre. Waveforms of sound waves include a square wave, a sawtooth wave, a sine wave, a pulse wave, and the like.

Sounds may be classified into a regular sound and an irregular sound based on features of sound waves. The irregular sound is a sound emitted by the sound source through irregular vibration. The irregular sound is, for example, noise that affects people's work, study, rest, and the like. The regular sound is a sound emitted by the sound source through regular vibration. Regular sounds include a voice and a music sound. When a sound is represented electrically, the regular sound is an analog signal that changes continuously in time-frequency domain. The analog signal may be referred to as an audio signal. The audio signal is an information carrier that carries a voice, music, and a sound effect.

Because human's auditory sense has a capability of distinguishing location distribution of the sound source in space, when hearing a sound in space, a listener can sense a direction and a location of the sound in addition to a tone, intensity, and a timbre of the sound.

As attention to and quality requirements for experience of an auditory system increase, a three-dimensional audio technology emerges accordingly, to enhance a sense of depth, a sense of presence, and a sense of space of a sound. Therefore, the listener not only senses sounds emitted from front, back, left, and right sound sources, but also senses a feeling that space in which the listener is located is enveloped by spatial sound fields (referred to as “sound field”) generated by these sound sources, and a feeling that the sounds diffuse around, to create an “immersive” sound effect exerted when the listener is located in a place such as a theater or a concert hall.

A scene audio signal in embodiments of the present disclosure may be a signal used to describe a sound field. The scene audio signal may include an HOA signal (the HOA signal may include a three-dimensional HOA signal and a two-dimensional HOA signal (which may also be referred to as a planar HOA signal)) and a three-dimensional audio signal. The three-dimensional audio signal may be an audio signal in the scene audio signal other than the HOA signal. The following provides descriptions by using the HOA signal as an example.

It is well known that the sound wave is propagated in an ideal medium, a quantity of waves is k=w/c, and an angular frequency is w=2πf. Herein, f is a sound wave frequency, and c is a sound speed. Sound pressure p satisfies Formula (1). Herein, ∇² is a Laplacian operator.

$${∇}^{2} p + {k}^{2} p = 0 \qquad ( 1 )$$

It is assumed that a spatial system outside the human ear is a sphere, and the listener is at a center of the sphere. A sound transmitted from the outside of the sphere has a projection on a spherical surface, and a sound outside the spherical surface is filtered out. It is assumed that a sound source is distributed on the spherical surface, and a sound field generated by the sound source on the spherical surface fits a sound field generated by an original sound source. That is, the three-dimensional audio technology is a sound field fitting method. For example, an equation, namely, Formula (1) is solved in a spherical coordinate system. In a passive spherical area, a solution to the equation, namely, Formula (1) is Formula (2).

$$p ( r , θ , φ , k ) = s {\sum }_{m = 0}^{∞} ( 2 m + 1 ) {j}^{m} {j}_{m}^{kr} ( kr ) {\sum }_{0 \leq n \leq m , σ \pm 1} {Y}_{m , n}^{σ} ( {θ}_{s} , {φ}_{s} ) {Y}_{m , n}^{σ} ( θ , φ ) \qquad ( 2 )$$

Herein, r represents a sphere radius, θ represents horizontal angle information (or referred to as azimuth information), φ represents pitch angle information (or referred to as elevation angle information), k represents the quantity of waves, s represents an amplitude of an ideal plane wave and m represents a sequence number of an order quantity of the HOA signal.

$${j}^{m} {j}_{m}^{k r} ( k r )$$

represents a sphere Bessel function, and the sphere Bessel function is also referred to as a radial basis function. First “j” represents an imaginary unit, and

$$( 2 m + 1 ) {j}^{m} {j}_{m}^{k r} ( k r )$$

does not change with an angle.

$${Y}_{m , n}^{σ} ( θ , φ )$$

represents a spherical harmonic function in directions of θ and φ, and

$${Y}_{m , n}^{σ} ( {θ}_{s} , {φ}_{s} )$$

represents a spherical harmonic function in a direction of the sound source. The HOA signal satisfies Formula (3).

$${B}_{m , n}^{σ} = s \cdot {Y}_{m , n}^{σ} ( {θ}_{s} , {φ}_{s} ) \qquad ( 3 )$$

Formula (3) is substituted into Formula (2), and Formula (2) may be deformed into Formula (4).

$$p ( r , θ , φ , k ) = {\sum }_{m = 0}^{∞} {j}^{m} {j}_{m}^{k r} ( k r ) {\sum }_{0 \leq n \leq m , σ = \pm 1} {B}_{m , n}^{σ} {Y}_{m , n}^{σ} ( θ , φ ) \qquad ( 4 )$$

Herein, m is truncated to an N^{th} item, that is, m=N, and

$${B}_{m , n}^{σ}$$

is used as an approximate description of the sound field. In this case,

$${B}_{m , n}^{σ}$$

may be referred to as an HOA coefficient (which may be used to represent an N-order HOA signal). The sound field is an area in which a sound wave exists in a medium. N is an integer greater than or equal to 1.

The scene audio signal is an information carrier that carries spatial location information of a sound source in the sound field, and describes a sound field of a listener in space. Formula (4) indicates that the sound field may be expanded on the spherical surface based on the spherical harmonic function. In other words, the sound field may be decomposed into superimposition of a plurality of plane waves. Therefore, the sound field described by the HOA signal may be expressed through superimposition of a plurality of plane waves, and the sound field is reconstructed based on the HOA coefficient.

A to-be-encoded HOA signal in embodiments of the present disclosure may be an N-order HOA signal, and may be represented by using an HOA coefficient or an ambisonic coefficient. N is an integer greater than or equal to 1 (when N is equal to 1, a 1-order HOA signal may be referred to as an FOA (first-order ambisonics, first-order ambisonics) signal). The N-order HOA signal includes an audio signal with (N+1)² channels.

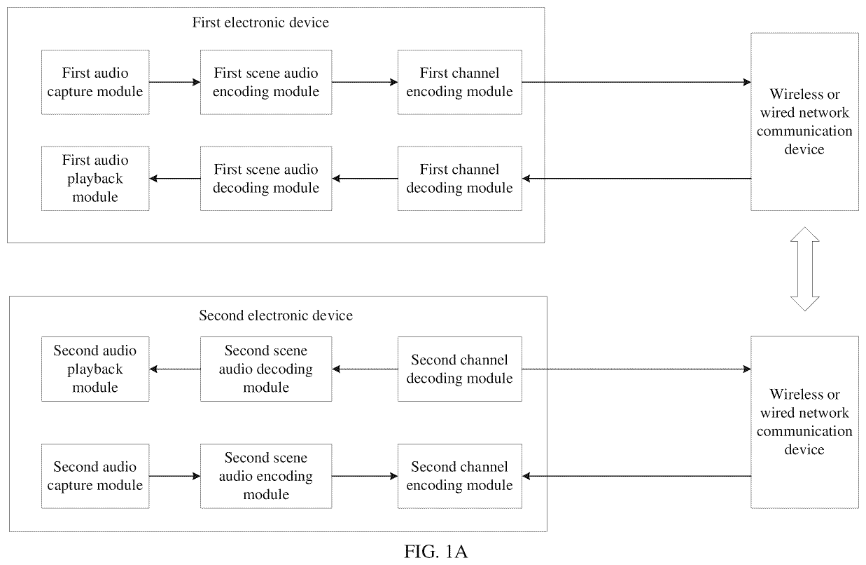

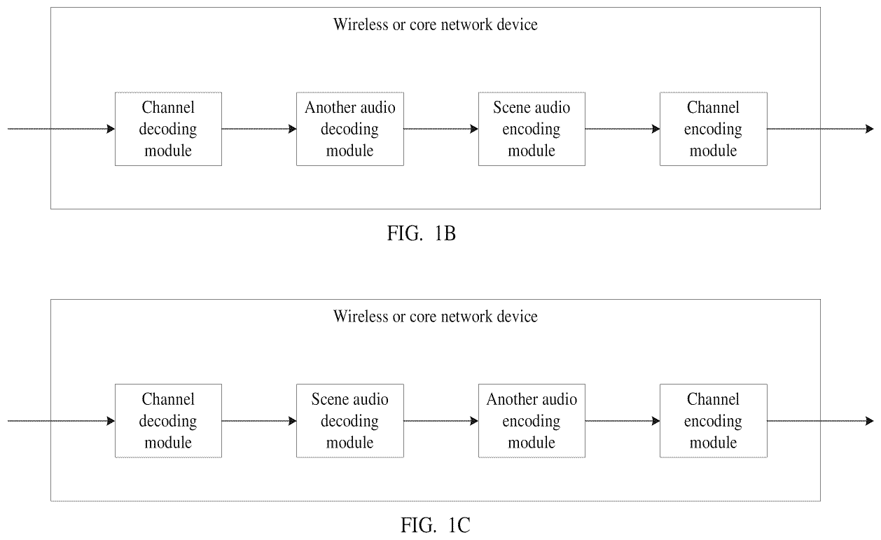

FIG. 1A is a diagram of an example application scenario. FIG. 1A shows a scenario of encoding and decoding a scene audio signal.

As shown in FIG. 1A, for example, a first electronic device may include a first audio capture module, a first scene audio encoding module, a first channel encoding module, a first channel decoding module, a first scene audio decoding module, and a first audio playback module. It should be understood that the first electronic device may include more or fewer modules than those shown in FIG. 1A. This is not limited in the present disclosure.

As shown in FIG. 1A, for example, a second electronic device may include a second audio capture module, a second scene audio encoding module, a second channel encoding module, a second channel decoding module, a second scene audio decoding module, and a second audio playback module. It should be understood that the second electronic device may include more or fewer modules than those shown in FIG. 1A. This is not limited in the present disclosure.

For example, a process in which the first electronic device encodes the scene audio signal and transmits the encoded scene audio signal to the second electronic device, and the second electronic device performs decoding and audio playback may be as follows: The first audio capture module may perform audio capture, and output the scene audio signal to the first scene audio encoding module. Then, the first scene audio encoding module may encode the scene audio signal, and output a bitstream to the first channel encoding module. Then, the first channel encoding module may perform channel encoding on the bitstream, and transmit, to the second electronic device through a wireless or wired network communication device, a bitstream obtained through channel encoding. Then, the second channel decoding module of the second electronic device may perform channel decoding on received data, to obtain a bitstream and output the bitstream to the second scene audio decoding module. Then, the second scene audio decoding module may decode the bitstream, to obtain a reconstructed scene audio signal; and then output the reconstructed scene audio signal to the second audio playback module, and the second audio playback module performs audio playback.

It should be noted that the second audio playback module may perform post-processing (for example, audio rendering (for example, a reconstructed scene audio signal including an audio signal with (N+1)² channels may be converted into an audio signal with a same channel quantity as a quantity of speakers in the second electronic device), loudness normalization, user interaction, audio format conversion, or denoising) on the reconstructed scene audio signal, to convert the reconstructed scene audio signal into an audio signal suitable for playing by the speaker in the second electronic device.

It should be understood that a process in which the second electronic device encodes a scene audio signal and transmits the encoded scene audio signal to the first electronic device, and the first electronic device performs decoding and audio playback is similar to the foregoing process in which the first electronic device transmits the scene audio signal to the second electronic device, and the second electronic device performs audio playback.

For example, the first electronic device and the second electronic device each may include but are not limited to a personal computer, a computer workstation, a smartphone, a tablet computer, a server, a smart camera, an intelligent vehicle, another type of cellular phone, a media consumption device, a wearable device, a set-top box, a game console, and the like.

For example, the present disclosure may be applied to a virtual-reality (VR)/augmented-reality (AR)scenario. In a possible manner, the first electronic device is a server, and the second electronic device is a VR/AR device. In a possible manner, the second electronic device is a server, and the first electronic device is a VR/AR device.

For example, the first scene audio encoding module and the second scene audio encoding module may be scene audio encoders. The first scene audio decoding module and the second scene audio decoding module may be scene audio decoders.

For example, when the first electronic device encodes the scene audio signal, and the second electronic device reconstructs the scene audio signal, the first electronic device may be referred to as an encoder side, and the second electronic device may be referred to as a decoder side. When the second electronic device encodes the scene audio signal, and the first electronic device reconstructs the scene audio signal, the second electronic device may be referred to as an encoder side, and the first electronic device may be referred to as a decoder side.

FIGS. 1B-1C are diagrams of an example application scenario. FIGS. 1B-1C show a transcoding scenario of a scene audio signal.

In FIG. 1B, for example, a wireless or core network device may include a channel decoding module, another audio decoding module, a scene audio encoding module, and a channel encoding module. The wireless or core network device may be configured to perform audio transcoding.

For example, a specific application scenario in FIG. 1B may be as follows: A first electronic device is not provided with a scene audio encoding module, and is provided with only another audio encoding module. A second electronic device is provided with only a scene audio decoding module, and is not provided with another audio decoding module. The wireless or core network device may be used for transcoding, so that the second electronic device can decode and play back a scene audio signal encoded by the first electronic device by using the another audio encoding module.

For example, the first electronic device encodes the scene audio signal by using the another audio encoding module, to obtain a first bitstream; and performs channel encoding on the first bitstream and sends the encoded first bitstream to the wireless or core network device. Then, the channel decoding module of the wireless or core network device may perform channel decoding, and output, to the another audio decoding module, the first bitstream obtained through channel decoding. Then, the another audio decoding module decodes the first bitstream, to obtain the scene audio signal, and outputs the scene audio signal to the scene audio encoding module. Then, the scene audio encoding module may encode the scene audio signal, to obtain a second bitstream, and output the second bitstream to the channel encoding module. After performing channel encoding on the second bitstream, the channel encoding module sends the encoded second bitstream to the second electronic device. In this way, the second electronic device may invoke the scene audio decoding module to decode the second bitstream obtained through channel decoding, to obtain a reconstructed scene audio signal; and subsequently, may perform audio playback on the reconstructed scene audio signal.

In FIG. 1C, for example, a wireless or core network device may include a channel decoding module, a scene audio decoding module, another audio encoding module, and a channel encoding module. The wireless or core network device may be configured to perform audio transcoding.

For example, a specific application scenario in FIG. 1C may be as follows: A first electronic device is provided with only a scene audio encoding module, and is not provided with another audio encoding module. A second electronic device is not provided with a scene audio decoding module, and is only provided with another audio decoding module. The wireless or core network device may be used for transcoding, so that the second electronic device can decode and play back a scene audio signal encoded by the first electronic device by using the scene audio encoding module.

For example, the first electronic device encodes the scene audio signal by using the scene audio encoding module, to obtain a first bitstream; and performs channel encoding on the first bitstream and sends the encoded first bitstream to the wireless or core network device. Then, the channel decoding module of the wireless or core network device may perform channel decoding, and output, to the scene audio decoding module, the first bitstream obtained through channel decoding. Then, the scene audio decoding module decodes the first bitstream, to obtain the scene audio signal, and outputs the scene audio signal to the another audio encoding module. Then, the another audio encoding module may encode the scene audio signal, to obtain a second bitstream, and output the second bitstream to the channel encoding module. After performing channel encoding on the second bitstream, the channel encoding module sends the encoded second bitstream to the second electronic device. In this way, the second electronic device may invoke the another audio decoding module to decode the second bitstream obtained through channel decoding, to obtain a reconstructed scene audio signal; and subsequently, may perform audio playback on the reconstructed scene audio signal.

The following describes scene audio signal encoding and decoding processes.

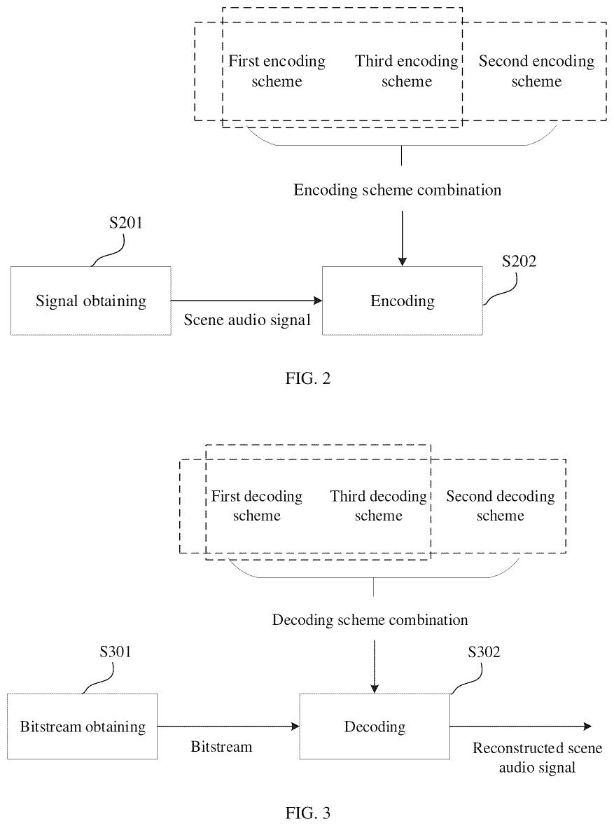

FIG. 2 is a diagram of an example scene audio signal encoding process.

S201: Obtain a scene audio signal.

For example, a to-be-encoded scene audio signal may be obtained. The scene audio signal may include an audio signal with C channels. C is a positive integer.

For example, when the scene audio signal is an HOA signal, the HOA signal may be an N-order HOA signal, namely,

$${B}_{m , n}^{σ}$$

in Formula (3) when m is truncated to an N^{th} item.

For example, the N-order HOA signal may include an audio signal with C channels. C=(N+1)². For example, when N=3, the N-order HOA signal includes an audio signal with 16 channels; and when N=4, the N-order HOA signal includes an audio signal with 25 channels.

For example, the scene audio signal may include one or more frames.

S202: Encode the scene audio signal based on the encoding scheme combination.

For example, the scene audio signal may be encoded based on an encoding scheme combination including a plurality of encoding schemes, to obtain a bitstream of the scene audio signal.

In a possible manner, a first encoding scheme, a second encoding scheme, and a third encoding scheme may form the encoding scheme combination.

In a possible manner, a first encoding scheme and a third encoding scheme may form the encoding scheme combination.

For example, the first encoding scheme may be encoding a signal, to be specific, performing operations such as time-frequency transform, preprocessing, bit allocation, quantization, and entropy encoding on the signal. The first encoding scheme may also be referred to as a direct encoding scheme.

For example, the second encoding scheme may be a spatial encoding scheme, and the spatial encoding scheme is encoding attribute information that is of a target virtual speaker and that is determined based on the scene audio signal. A process of determining the attribute information of the target virtual speaker based on the scene audio signal is described below.

For example, the third encoding scheme may include one or more encoding schemes other than the first encoding scheme and the second encoding scheme.

In a possible manner, the third encoding scheme is channel copy (or HOA copy) encoding. Optionally, the third encoding scheme is a de-correlation encoding scheme. It should be understood that a quantity and types of encoding schemes included in the third encoding scheme are not limited in the present disclosure.

It should be understood that the encoding scheme combination includes at least one of the following combinations: a combination of the first encoding scheme and the third encoding scheme, or a combination of the first encoding scheme, the second encoding scheme, and the third encoding scheme.

Performing encoding based on a direct encoding scheme (for example, the first encoding scheme) can improve encoding quality, but requires high bit rate overheads; and performing encoding based on another encoding scheme (the second encoding scheme or the third encoding scheme) can reduce bit rate overheads, but reduces encoding quality. Therefore, performing encoding based on a combination of the direct encoding scheme and the another encoding scheme in the present disclosure reduces bit rate overheads and encoding complexity while ensuring encoding quality to some extent.

When bit rate overheads required by the third encoding scheme are lower than bit rate overheads required by the second encoding scheme, for example, the third encoding scheme is the channel copy encoding scheme, compared with encoding the scene audio signal based on the combination of the first encoding scheme, the second encoding scheme, and the third encoding scheme, encoding the scene audio signal based on the combination of the first encoding scheme and the third encoding scheme in the present disclosure can reduce bit rate overheads and encoding complexity.

In a possible manner, an encoder side and a decoder side may pre-agree on a type of the encoding scheme combination (or a decoding scheme combination).

In a possible manner, an encoder side and a decoder side do not pre-agree on a type of the encoding scheme combination (or a decoding scheme combination). In this case, the encoder side may further encode a second preset identifier. The second preset identifier may indicate the type of the encoding scheme combination (or the decoding scheme combination). In this way, after the second preset identifier is transmitted to the decoder side by using the bitstream, the decoder side may learn of the type of the encoding scheme combination (or the decoding scheme combination), and perform decoding based on the decoding scheme combination corresponding to the encoding scheme combination of the encoder side, to obtain a reconstructed scene audio signal.

FIG. 3 is a diagram of an example scene audio decoding process. The embodiment in FIG. 3 is a decoding process corresponding to the encoding process in the embodiment in FIG. 2.

S301: Receive a bitstream.

S302: Decode the bitstream based on a decoding scheme combination, to obtain a reconstructed scene audio signal.

For example, the bitstream may be decoded based on a decoding scheme combination including a plurality of decoding schemes, to obtain the reconstructed scene audio signal.

In a possible manner, a first decoding scheme, a second decoding scheme, and a third decoding scheme may form the decoding scheme combination.

In a possible manner, a first decoding scheme and a third decoding scheme may form the decoding scheme combination.

For example, the first decoding scheme may be decoding encoded data obtained by encoding a signal, to be specific, performing operations such as entropy decoding, dequantization, bit allocation, post-processing, and time-frequency transform on the encoded data obtained by encoding the signal. The first decoding scheme may also be referred to as a direct decoding scheme.

For example, the second decoding scheme may be a spatial decoding scheme, and the spatial decoding scheme is performing reconstruction based on attribute information of a target virtual speaker. A process of performing reconstruction based on the attribute information of the target virtual speaker is described below.

For example, the third decoding scheme may include one or more decoding schemes other than the first decoding scheme and the second decoding scheme. In a possible manner, the third decoding scheme may be channel copy (HOA copy) decoding. Optionally, the third decoding scheme is a de-correlation decoding scheme. It should be understood that a quantity and types of decoding schemes included in the third decoding scheme are not limited in the present disclosure.

It should be understood that the decoding scheme combination includes at least one of the following combinations: a combination of the first decoding scheme and the third decoding scheme, or a combination of the first decoding scheme, the second decoding scheme, and the third decoding scheme.

For example, when an encoder side and a decoder side pre-agree on a type of an encoding scheme combination (the decoding scheme combination), the decoder side may decode the bitstream based on the pre-agreed decoding scheme combination, to obtain the reconstructed scene audio signal.

For example, when an encoder side and a decoder side do not pre-agree on a type of an encoding scheme combination (or the decoding scheme combination), the decoder side may parse out a second preset identifier from the bitstream, and then decode the bitstream based on a decoding scheme combination corresponding to the second preset identifier, to obtain the reconstructed scene audio signal.

In this way, when the third decoding scheme is the channel copy decoding scheme, a fluctuation degree of the reconstructed scene audio signal obtained through decoding can be reduced, and audio smoothness can be improved.

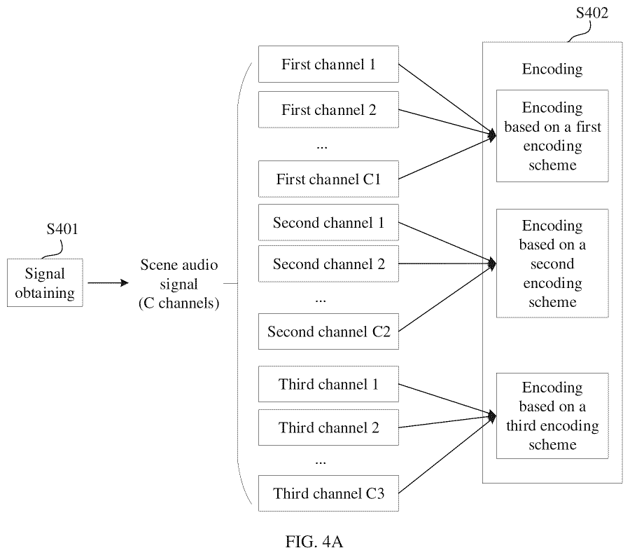

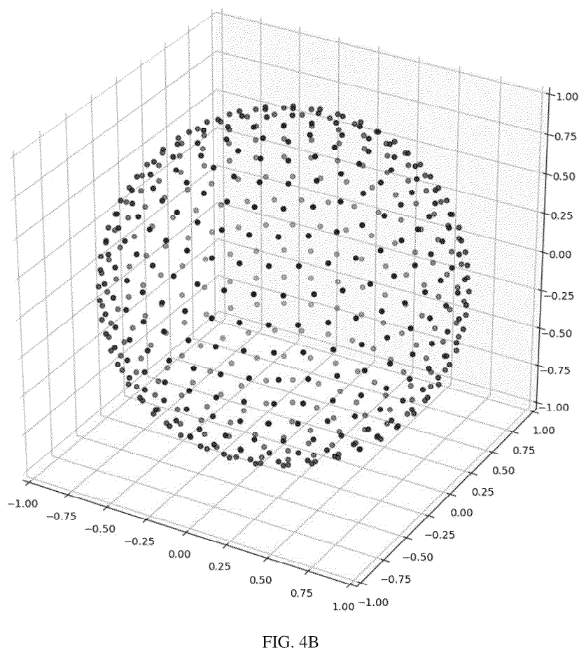

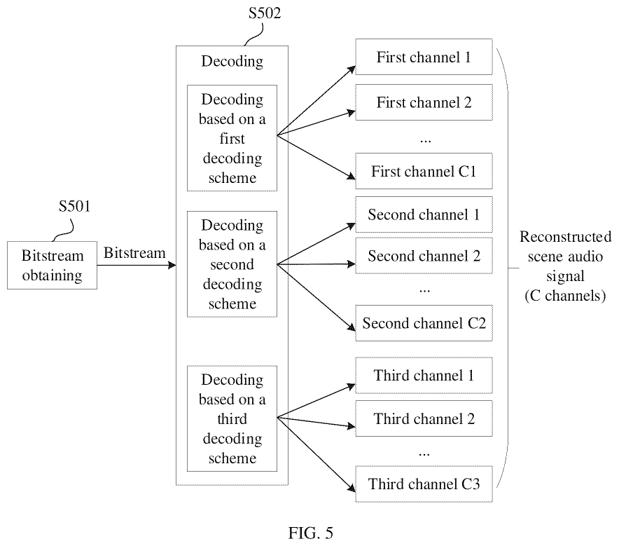

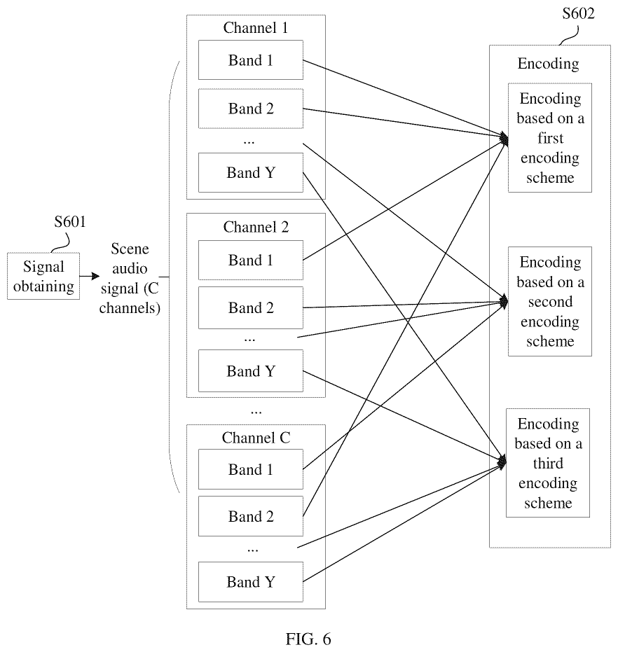

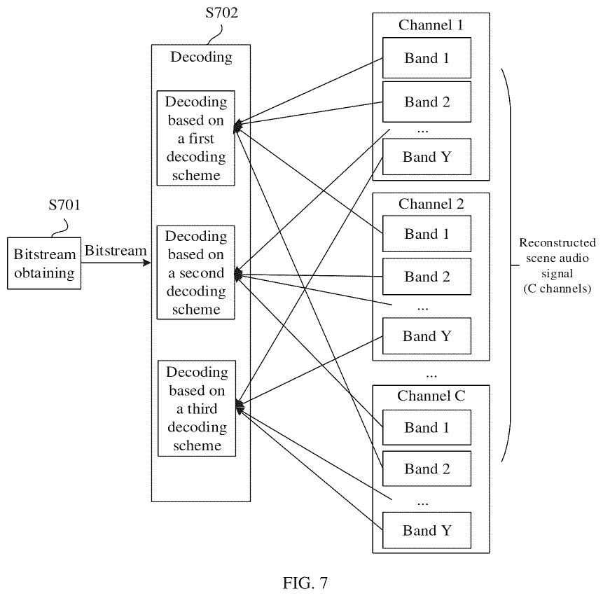

In a possible manner, when a to-be-encoded scene audio signal includes one frame, the frame of scene audio signal may be encoded based on a plurality of encoding schemes in the encoding scheme combination. Descriptions may be provided with reference to the embodiment in FIG. 4A or the embodiment in FIG. 6. Correspondingly, the decoder side receives one frame of bitstream, and decodes the frame of bitstream based on a plurality of decoding schemes in the decoding scheme combination, to obtain one frame of reconstructed scene audio signal. Reference may be made to the following description of the embodiment in FIG. 5 or the embodiment in FIG. 7.

In a possible manner, when a to-be-encoded scene audio signal includes a plurality of frames, each frame of scene audio signal may be encoded based on a plurality of encoding schemes in the encoding scheme combination. Descriptions may be provided with reference to the embodiment in FIG. 4A or the embodiment in FIG. 6. Correspondingly, the decoder side receives a plurality of frames of bitstreams, and decodes each frame of bitstream based on a plurality of decoding schemes in the decoding scheme combination, to obtain one frame of reconstructed scene audio signal. Reference may be made to the following description of the embodiment in FIG. 5 or the embodiment in FIG. 7.

The following describes encoding and decoding processes of one frame of scene audio signal by using an example in which a third encoding scheme is a de-correlation encoding scheme.

FIG. 4A is a diagram of an example scene audio encoding process. In the embodiment in FIG. 4A, a plurality of channels in one frame of scene audio signal are encoded based on a plurality of encoding schemes in an encoding scheme combination. The encoding scheme combination is a combination of a first encoding scheme, a second encoding scheme, and a third encoding scheme.

S401: Obtain a scene audio signal, where the scene audio signal includes an audio signal with C channels.

S402: For the scene audio signal, encode C1 first channels based on the first encoding scheme, encode C2 second channels based on the second encoding scheme, and encode C3 third channels based on the third encoding scheme.

For example, for one frame of scene audio signal, it may be determined that in C channels included in the frame of scene audio signal, C1 first channels are encoded based on the first encoding scheme, C2 second channels are encoded based on the second encoding scheme, and C3 third channels are encoded based on the third encoding scheme. C is equal to a sum of C1, C2, and C3, C, C1, C2, and C3 are positive integers, and the first channel, the second channel, and the third channel are different channels.

Then, the C1 first channels are encoded based on the first encoding scheme, the C2 second channels are encoded based on the second encoding scheme, and the C3 third channels are encoded based on the third encoding scheme, to obtain a bitstream of the frame of scene audio signal.

For example, a process of encoding the C1 first channels based on the first encoding scheme may be: encoding an audio signal with the C1 first channels based on a direct encoding scheme, to be specific, performing operations such as time-frequency transform, preprocessing, bit allocation, quantization, and entropy encoding on the audio signal with the C1 first channels, to obtain encoded data of the audio signal with the C1 first channels.

For example, a process of encoding the C2 second channels based on the second encoding scheme may be: determining attribute information of a target virtual speaker based on the scene audio signal; and encoding the attribute information of the target virtual speaker.

For example, the virtual speaker is a speaker that is virtual, and is not a speaker that actually exists.

For example, it can be learned, based on the foregoing descriptions, that the scene audio signal may be expressed through superimposition of a plurality of plane waves, and further, a target virtual speaker used to simulate a sound source in the scene audio signal may be determined. In this way, in a subsequent decoding process, a virtual speaker signal corresponding to the target virtual speaker is used to reconstruct the scene audio signal.

In a possible manner, a plurality of candidate virtual speakers at different locations may be disposed on a spherical surface; and then, a target virtual speaker whose location matches a location of the sound source in the scene audio signal may be selected from the plurality of candidate virtual speakers.

FIG. 4B is a diagram of an example distribution of candidate virtual speakers. In FIG. 4B, the plurality of candidate virtual speakers may be evenly distributed on the spherical surface, and one point on the spherical surface represents one candidate virtual speaker.

It should be noted that a quantity of candidate virtual speakers and a distribution of the candidate virtual speakers are not limited in the present disclosure, and may be set according to a requirement. Details are described subsequently.

For example, the target virtual speaker whose location corresponds to the location of the sound source in the scene audio signal may be selected from the plurality of candidate virtual speakers based on the scene audio signal. There may be one or more target virtual speakers. This is not limited in the present disclosure. For details, refer to S11 to S13.

S11: Obtain a plurality of groups of virtual speaker coefficients corresponding to the plurality of candidate virtual speakers, where the plurality of groups of virtual speaker coefficients is in one-to-one correspondence with the plurality of candidate virtual speakers.

For example, first configuration information of an encoding module (for example, a scene audio encoding module) may be obtained; second configuration information of the candidate virtual speaker is determined based on the first configuration information of the encoding module; and the plurality of candidate virtual speakers are generated based on the second configuration information of the candidate virtual speaker.

For example, the first configuration information includes, but is not limited to, an encoding bit rate and user-defined information (for example, an HOA order quantity (which is an order quantity of an HOA signal that may be encoded by the encoding module) corresponding to the encoding module, an order quantity (an expected order quantity of a reconstructed HOA signal obtained by a decoder side through decoding) of a reconstructed scene audio signal, and a format (an expected format of the reconstructed HOA signal obtained by the decoder side through decoding) of the reconstructed scene audio signal). This is not limited in the present disclosure.

For example, the second configuration information includes, but is not limited to, information such as a total quantity of candidate virtual speakers, an HOA order quantity of each candidate virtual speaker, and location information of each candidate virtual speaker. This is not limited in the present disclosure.

For example, the second configuration information of the candidate virtual speaker may be determined based on the first configuration information of the encoding module in a plurality of manners. For example, a small quantity of candidate virtual speakers may be configured if the encoding bit rate is low; or a plurality of candidate virtual speakers may be configured if the encoding bit rate is high. For another example, the HOA order quantity of the virtual speaker may be configured as the HOA order quantity of the encoding module. In this embodiment of the present disclosure, in addition to determining the second configuration information of the candidate virtual speaker based on the first configuration information of the encoding module, the second configuration information of the candidate virtual speaker may also be determined based on the user-defined information (for example, information such as the total quantity of candidate virtual speakers, the HOA order quantity of each candidate virtual speaker, and the location information of each candidate virtual speaker that may be customized by a user). This is not limited.

For example, a configuration table may be preset. The configuration table includes a relationship between a quantity of candidate virtual speakers and location information of the candidate virtual speakers. In this way, after the total quantity of candidate virtual speakers is determined, the location information of each candidate virtual speaker may be determined by searching the configuration table.

For example, after the second configuration information of the candidate virtual speaker is determined, the plurality of candidate virtual speakers may be generated based on the second configuration information of the candidate virtual speaker. For example, a corresponding quantity of candidate virtual speakers may be generated based on the total quantity of candidate virtual speakers, and the HOA order quantity of each candidate virtual speaker is set based on the HOA order quantity of each candidate virtual speaker; and a location of each candidate virtual speaker is set based on the location information of each candidate virtual speaker.

For example, when each candidate virtual speaker serves as a virtual sound source, a virtual speaker signal generated by the virtual sound source is a plane wave, and the plane wave may be expanded in a spherical coordinate system. For an ideal plane wave whose amplitude is s and direction is (θₛ,φₛ), a form obtained through expansion based on a spherical harmonic function may be shown in Formula (3). The HOA order quantity of the candidate virtual speaker is a truncated value of m in Formula (3).

Then, a virtual speaker coefficient corresponding to each candidate virtual speaker may be determined based on the HOA order quantity of each candidate virtual speaker (each candidate virtual speaker corresponds to one group of virtual speaker coefficients). For example, for a candidate virtual speaker, with reference to Formula (3), the truncated value of m in Formula (3) is set to the HOA order quantity of the candidate virtual speaker, and (θₛ,φₛ) in Formula (3) is set to the location information (θₛ₃,φₛ₃) of the candidate virtual speaker. In this case,

$${B}_{m , n}^{σ}$$

in Formula (3) is one group of virtual speaker coefficients (the virtual speaker coefficient is also an HOA coefficient. It should be noted that, it can be learned from Formula (3) that when the location of the candidate virtual speaker is different from the location of the sound source in the scene audio signal, the virtual speaker coefficient of the candidate virtual speaker and the scene audio signal are different HOA coefficients). In this way, one group of virtual speaker coefficients corresponding to each candidate virtual speaker may be determined.

S12: Select the target virtual speaker from the plurality of candidate virtual speakers based on the scene audio signal and the plurality of groups of virtual speaker coefficients.

For example, a dot product of the scene audio signal and each of the plurality of groups of virtual speaker coefficients is obtained, to obtain a plurality of dot product values. The plurality of dot product values is in one-to-one correspondence with the plurality of groups of virtual speaker coefficients. For example, a dot product of one group of virtual speaker coefficients corresponding to each of the plurality of candidate virtual speakers and the scene audio signal may be obtained, to obtain a corresponding dot product value.

Then, the target virtual speaker may be selected from the plurality of candidate virtual speakers based on the plurality of dot product values. In a possible manner, first G (G is a positive integer) candidate virtual speakers with largest dot product values may be selected as target virtual speakers. In a possible manner, a candidate virtual speaker with a largest dot product may be first selected as a target virtual speaker; the scene audio signal is projected and superimposed on a linear combination of a group of virtual speaker coefficients corresponding to the candidate virtual speaker with the largest dot product, to obtain a projection vector; and the projection vector is subtracted from the scene audio signal, to obtain a difference. Then, the foregoing process is repeated for the difference, to implement iterative calculation, and one target virtual speaker is generated each time of iteration.

S13: Obtain the attribute information of the target virtual speaker.

In a possible manner, the attribute information of the target virtual speaker is generated based on location information of the target virtual speaker. In a possible manner, the location information (including pitch angle information and horizontal angle information) of the target virtual speaker may be used as the attribute information of the target virtual speaker. In a possible manner, a location index (including a pitch angle index (which may be used to uniquely identify the pitch angle information) and a horizontal angle index (which may be used to uniquely identify the horizontal angle information)) corresponding to the location information of the target virtual speaker are used as the attribute information of the target virtual speaker.

In a possible manner, a virtual speaker index (for example, a virtual speaker identifier) of the target virtual speaker may be used as the attribute information of the target virtual speaker. The virtual speaker index is in one-to-one correspondence with the location information.

In a possible manner, the virtual speaker coefficient of the target virtual speaker may be used as the attribute information of the target virtual speaker. For example, C virtual speaker coefficients of the target virtual speaker may be determined, and the C virtual speaker coefficients of the target virtual speaker are used as the attribute information of the target virtual speaker. The C virtual speaker coefficients of the target virtual speaker are in one-to-one correspondence with an audio signal with C channels included in the reconstructed scene audio signal.

It should be noted that, a data amount of the virtual speaker coefficient is far greater than a data amount of the location information, a data amount of an index of the location information, and a data amount of the virtual speaker index. Specific information that is in the location information, the index of the location information, the virtual speaker index, and the virtual speaker coefficient and that is used as the attribute information of the target virtual speaker may be determined based on a bandwidth. For example, when the bandwidth is large, the virtual speaker coefficient may be used as the attribute information of the target virtual speaker. In this way, the decoder side does not need to calculate the virtual speaker coefficient of the target virtual speaker, and computational power of the decoder side may be saved. When the bandwidth is small, any one of the location information, the index of the location information, and the virtual speaker index may be used as the attribute information of the target virtual speaker. In this way, a bit rate may be reduced. It should be understood that, specific information that is in the location information, the index of the location information, the virtual speaker index, and the virtual speaker coefficient and that is used as the attribute information of the target virtual speaker may alternatively be preset. This is not limited in the present disclosure.

In a possible manner, the target virtual speaker may be preset.

It should be understood that a manner of determining the target virtual speaker is not limited in the present disclosure, and a manner of determining the attribute information of the target virtual speaker is not limited in the present disclosure.

For example, when the third encoding scheme is a de-correlation encoding scheme, encoding the C3 third channels based on the third encoding scheme may be not processing an audio signal with the C3 third channels; but instead, the decoder side performs the de-correlation decoding scheme for the C3 third channels, to determine a reconstructed audio signal with the C3 third channels.

In a possible manner, the de-correlation encoding scheme may include a time-domain de-correlation encoding scheme and a frequency-domain de-correlation encoding scheme. When the third encoding scheme is the de-correlation encoding scheme, encoding the C3 third channels based on the third encoding scheme may be: determining, for the C3 third channels, whether the third encoding scheme is the time-domain de-correlation encoding scheme or the frequency-domain de-correlation encoding scheme. When the third encoding scheme is the time-domain de-correlation encoding scheme, the audio signal with the C3 third channels may not be processed; but instead, a value of a first preset identifier is set to a first preset value, and a first preset identifier corresponding to the C3 third channels is encoded. The first preset identifier that is set to the first preset value indicates that the third encoding scheme of the C3 third channels is the time-domain de-correlation encoding scheme. When the third encoding scheme is the frequency-domain de-correlation encoding scheme, the audio signal with the C3 third channels may not be processed; but instead, a value of a first preset identifier is set to a second preset value, and a first preset identifier corresponding to the C3 third channels is encoded. The first preset identifier that is set to the second preset value indicates that the third encoding scheme of the C3 third channels is the frequency-domain de-correlation encoding scheme. In this way, the decoder side learns of whether the third encoding scheme is the time-domain de-correlation encoding scheme or the frequency-domain de-correlation encoding scheme, and then perform decoding based on a corresponding de-correlation decoding scheme algorithm.

The following describes, by using an example in which the scene audio signal is an N-order HOA signal, how to determine the C1 first channels, the C2 second channels, and the C3 third channels.

For example, the C1 first channels may be C1 channels included in a 0^{th} order to an M^{th} order of the N-order HOA signal, M is an integer less than N, C is equal to a square of (N+1), and C1 is less than or equal to a square of (M+1).

For example, the C2 second channels may include other C4 channels included in the 0^{th} order to the M^{th} order of the N-order HOA signal, and C5 channels in the N-order HOA signal other than channels included in the 0^{th} order to the M^{th} order.

For example, the C3 third channels may include other C6 channels included in the 0^{th} order to the M^{th} order of the N-order HOA signal, and other C7 channels in the N-order HOA signal other than channels included in the 0^{th} order to the M^{th} order.

C2=C4+C5, C3=C6+C7, C1+C4+C6=Square of (M+1), and C4, C5, C6, and C7 are integers.

If N=3, C=16. To be specific, a 3-order HOA signal includes 16 channels.

When a value of n in Formula (3) is 0, one monomial may be obtained by expanding Formula (3), as shown in Formula (5). In this case, an audio signal with one channel (referred to as a channel 1 below) may be obtained. When the value of n in Formula (3) is 1, three monomials may be obtained by expanding Formula (3), as shown in Formula (6). In this case, an audio signal with three channels (referred to as a channel 2, a channel 3, and a channel 4 in sequence) may be obtained. When a value of n in Formula (3) is 2, five monomials may be obtained by expanding Formula (3), as shown in Formula (7). In this case, an audio signal with five channels (referred to as a channel 5, a channel 6, channel 7, a channel 8, and a channel 9 in sequence) may be obtained. When the value of n in Formula (3) is 3, seven monomials may be obtained by expanding Formula (3), as shown in Formula (8). In this case, an audio signal with seven channels (referred to as a channel 10, a channel 11, channel 12, a channel 13, a channel 14, a channel 15, and a channel 16 in sequence) may be obtained. Each monomial corresponds to one channel, and each monomial may represent an audio signal with one channel.

$$B {1}_{3 , 0}^{0} = s \cdot {Y}_{3 , 0}^{0} ( {θ}_{s 1} , {φ}_{s 1} ) \qquad ( 5 )$$

$$B {1}_{3 , 1}^{0} = s \cdot {Y}_{3 , 1}^{0} ( {θ}_{s 1} , {φ}_{s 1} ) , B {1}_{3 , 1}^{- 1} = s \cdot {Y}_{3 , 1}^{- 1} ( {θ}_{s 1} , {φ}_{s 1} ) , B {1}_{3 , 1}^{1} = s \cdot {Y}_{3 , 1}^{1} ( {θ}_{s 1} , {φ}_{s 1} ) \qquad ( 6 )$$

$$\begin{matrix}B {1}_{3 , 2}^{0} = s \cdot {Y}_{3 , 2}^{0} ( {θ}_{s 1} , {φ}_{s 1} ) , B {1}_{3 , 2}^{- 1} = s \cdot {Y}_{3 , 2}^{- 1} ( {θ}_{s 1} , {φ}_{s 1} ) , B {1}_{3 , 2}^{1} = s \cdot {Y}_{3 , 2}^{1} ( {θ}_{s 1} , {φ}_{s 1} ) , \\ B {1}_{3 , 2}^{- 2} = s \cdot {Y}_{3 , 2}^{- 2} ( {θ}_{s 1} , {φ}_{s 1} ) , B {1}_{3 , 2}^{2} = s \cdot {Y}_{3 , 2}^{2} ( {θ}_{s 1} , {φ}_{s 1} )\end{matrix} \qquad ( 7 )$$

$$\begin{matrix}B {1}_{3 , 3}^{0} = s \cdot {Y}_{3 , 3}^{0} ( {θ}_{s 1} , {φ}_{s 1} ) , B {1}_{3 , 3}^{- 1} = s \cdot {Y}_{3 , 3}^{- 1} ( {θ}_{s 1} , {φ}_{s 1} ) , B {1}_{3 , 2}^{1} = s \cdot {Y}_{3 , 3}^{1} ( {θ}_{s 1} , {φ}_{s 1} ) , \\ B {1}_{3 , 3}^{- 2} = s \cdot {Y}_{3 , 3}^{- 2} ( {θ}_{s 1} , {φ}_{s 1} ) , B {1}_{3 , 3}^{2} = s \cdot {Y}_{3 , 3}^{2} ( {θ}_{s 1} , {φ}_{s 1} ) , B {1}_{3 , 2}^{- 3} = s \cdot {Y}_{3 , 3}^{- 3} ( {θ}_{s 1} , {φ}_{s 1} ) , \\ B {1}_{3 , 3}^{3} = s \cdot {Y}_{3 , 3}^{3} ( {θ}_{s 1} , {φ}_{s 1} )\end{matrix} \qquad ( 8 )$$

Herein, (θₛ₁,φₛ₁) is location information of the sound source in the scene audio signal.

For example, if M=0, that is, m in Formula (3) is equal to 0, a value of n may be 0. One monomial may be obtained by expanding Formula (3). In other words, a 0^{th} order in the 3-order HOA signal includes one channel, namely, the channel 1. In this case, C1=1. To be specific, the first channel is the channel 1, C4=0, and C6=0. Correspondingly, in addition to the channel included in the 0^{th} order, the 3-order HOA signal further includes other 15 channels, namely, the channel 2 to the channel 16. The C5 channels may be selected from the 15 channels as second channels, and the C7 channels may be selected as third channels.

An example is provided.

If C5=14 and C7=1, the C2 second channels are the channel 2 to the channel 15, and the C3 third channels are the channel 16; or the C2 second channels are the channel 2 to the channel 13 and the channel 16, and the C3 third channels are the channel 15. This may be set according to a requirement. This is not limited in the present disclosure.

For example, if M=1, that is, m in Formula (3) is equal to 1, values of n may be 0 and 1. Four monomials may be obtained by expanding Formula (3). In other words, a 0^{th} order and a 11 order in the 3-order HOA signal include four channels, namely, the channel 1 to the channel 4. In this case, from the four channels, the C1 first channels may be selected, the other C4 channels may be selected as second channels, and the other C6 channels may be selected as third channels. Correspondingly, in addition to the channel included in the 0^{th} order and the 1^{st} order, the 3-order HOA signal further includes other 12 channels, namely, the channel 5 to the channel 16. The C5 channels may be selected from the 12 channels as second channels, and the C7 channels may be selected as third channels.

An example is provided.

If C1=4, C4=0, C6=0, C5=10, and C7=2, the C1 first channels are the channel 1 to the channel 4, the C2 second channels are the channel 5 to the channel 14, and the C3 third channels are the channel 16 and the channel 15; or the C1 first channels are the channel 1 to the channel 4, the C2 second channels are the channel 5 to the channel 10 and the channel 13 to the channel 16, and the C3 third channels are the channel 11 and the channel 12. This may be set according to a requirement. This is not limited in the present disclosure.

For example, if M=2, that is, m in Formula (3) is equal to 2, values of n may be 0, 1, and 2. Nine monomials may be obtained by expanding Formula (3). In other words, a 0^{th} order to a 2^{nd} order in the 3-order HOA signal include nine channels, namely, the channel 1 to the channel 9. In this case, from the nine channels, the C1 first channels may be selected, the other C4 channels may be selected as second channels, and the other C6 channels may be selected as third channels. Correspondingly, in addition to the channel included in the 0^{th} order to the 2^{nd} order, the 3-order HOA signal further includes other seven channels, namely, the channel 10 to the channel 16. The C5 channels may be selected from the seven channels as second channels, and the C7 channels may be selected as third channels.

An example is provided.

For example, if C1=8, C4=1, C6=0, C5=5, and C7=2, the C1 first channels include the channel 1 to the channel 5 and the channel 7 to the channel 9, the C2 second channels include the channel 6 and the channel 11 to the channel 15, and the C3 third channels include the channel 10 and the channel 16. Correspondingly, encoding schemes corresponding to the 16 channels may be shown as “sub-combination 2” in a third column in Table 1.

For example, if C1=9, C4=0, C6=0, C5=5, and C7=2, the C1 first channels include the channel 1 to the channel 9, the C2 second channels include the channel 11 to the channel 15, and the C3 third channels include the channel 10 and the channel 16. Correspondingly, encoding schemes corresponding to the 16 channels may be shown as “sub-combination 3” in a fourth column in Table 1.

It should be understood that C1, C2, and C3 may be set to other values, and the first channel, the second channel, and the third channel may be selected in another manner. In this way, for 16 channels in one frame of scene audio signal, r (r is a positive integer greater than or equal to 2) sub-combinations may be obtained. This is not limited in the present disclosure.

TABLE 1

| | | | | | |
|---|---|---|---|---|---|
| Channel | Sub-combination 1 | Sub-combination 2 | Sub-combination 3 | . . . | Sub-combination r |

| | | | |
|---|---|---|---|
| 1 | Direct | Direct | Direct |
| | encoding scheme | encoding scheme | encoding scheme |
| 2 | De-correlation | Direct | Direct |
| | encoding scheme | encoding scheme | encoding scheme |
| 3 | De-correlation | Direct | Direct |
| | encoding scheme | encoding scheme | encoding scheme |
| 4 | De-correlation | Direct | Direct |
| | encoding scheme | encoding scheme | encoding scheme |
| 5 | De-correlation | Direct | Direct |
| | encoding scheme | encoding scheme | encoding scheme |
| 6 | De-correlation | Spatial | Direct |
| | encoding scheme | encoding scheme | encoding scheme |
| 7 | De-correlation | Direct | Direct |
| | encoding scheme | encoding scheme | encoding scheme |
| 8 | De-correlation | Direct | Direct |
| | encoding scheme | encoding scheme | encoding scheme |
| 9 | De-correlation | Direct | Direct |
| | encoding scheme | encoding scheme | encoding scheme |
| 10 | De-correlation | De-correlation | De-correlation |
| | encoding scheme | encoding scheme | encoding scheme |
| 11 | De-correlation | Spatial | Spatial |
| | encoding scheme | encoding scheme | encoding scheme |
| 12 | De-correlation | Spatial | Spatial |
| | encoding scheme | encoding scheme | encoding scheme |
| 13 | De-correlation | Spatial | Spatial |
| | encoding scheme | encoding scheme | encoding scheme |
| 14 | De-correlation | Spatial | Spatial |
| | encoding scheme | encoding scheme | encoding scheme |
| 15 | De-correlation | Spatial | Spatial |
| | encoding scheme | encoding scheme | encoding scheme |
| 16 | De-correlation | De-correlation | De-correlation |
| | encoding scheme | encoding scheme | encoding scheme |

For example, when the encoding combination manner is the combination of the first encoding scheme and the third encoding scheme, C8 fourth channels may be encoded based on the first encoding scheme, and the C9 fifth channels may be encoded based on the third encoding scheme.

The C8 fourth channels are C8 channels included in the 0^{th} order to the M^{th} order in the N-order HOA signal. M is an integer less than N, C is equal to a square of (N+1), and C8 is less than or equal to a square of (M+1). The C9 fifth channels include other C10 channels included in the 0^{th} order to the M^{th} order in the N-order HOA signal, and channels in the N-order HOA signal other than channels included in the 0^{th} order to the M^{th} order. C8+C10 is equal to a square of (M+1).

For example, if M=0, that is, m in Formula (3) is equal to 0, a value of n may be 0. One monomial may be obtained by expanding Formula (3). In other words, a 0^{th} order in the 3-order HOA signal includes one channel, namely, the channel 1. In this case, C8=1. To be specific, the fourth channel is the channel 1, and C10=0. Correspondingly, in addition to the channel included in the 0^{th} order, the 3-order HOA signal further includes other 15 channels, namely, the channel 2 to the channel 16, which are all fifth channels. In this case, encoding schemes corresponding to the 16 channels may be shown as “sub-combination 1” in the second column in Table 1.

For example, if M=1, that is, m in Formula (3) is equal to 1, values of n may be 0 and 1. Four monomials may be obtained by expanding Formula (3). In other words, a 0^{th} order and a 1^{st} order in the 3-order HOA signal include four channels, namely, the channel 1 to the channel 4. In this case, from the four channels, the C8 channels may be selected as third channels, and the other C10 channels may be selected as fifth channels. Correspondingly, in addition to the channel included in the 0^{th} order and the 1^{st} order, the 3-order HOA signal further includes other 12 channels, namely, the channel 5 to the channel 16, which are all fifth channels.

An example is provided.

If C8=4, C10=0, and C9=12, the C8 fourth channels are the channel 1 to the channel 4, and the C9 fifth channels are the channel 5 to the channel 16.

If C8=2, C10=2, and C9=12, the C8 fourth channels are the channel 1 to the channel 2, and the C9 fifth channels are the channel 3 to the channel 16.

For example, if M=2, that is, m in Formula (3) is equal to 2, values of n may be 0, 1, and 2. Nine monomials may be obtained by expanding Formula (3). In other words, a 0^{th} order to a 2^{nd} order in the 3-order HOA signal include nine channels, namely, the channel 1 to the channel 9. In this case, from the nine channels, the C8 channels may be selected as fourth channels, and the other C10 channels may be selected as fifth channels. Correspondingly, in addition to the channel included in the 0^{th} order to the 2^{nd} order, the 3-order HOA signal further includes other seven channels, namely, the channel 10 to the channel 16, which are all fifth channels.

An example is provided.

For example, if C8=8, C10=0, and C9=8, the C8 fourth channels include the channel 1 to the channel 8, and the C9 fifth channels include the channel 9 to the channel 16.

It should be noted that a value of M, values of C1 to C10, and channels included in the C1 first channels, channels included in the C2 second channels, channels specifically included in the C3 third channels, channels included in the C8 fourth channels, and channels included in the C9 fifth channels may be determined based on features of audio signals with different channels. The features of the audio signals with different channels may include directions, and directions of the audio signals with different channels may be shown in Table 2.

TABLE 2

| Channel | Direction |
|---|---|
| 1 | Omnidirectional |
| 2 | Y direction |
| 3 | Z direction |
| 4 | X direction |
| 5 | V direction |
| 6 | T direction |
| 7 | R direction |
| 8 | S direction |
| 9 | U direction |
| 10 | Q direction |
| 11 | O direction |
| 12 | M direction |
| 13 | K direction |
| 14 | L direction |
| 15 | N direction |
| 16 | P direction |

For example, from the channels in the N-order HOA signal other than the channels included in the 0^{th} order to the M^{th}h order, C7 channels whose longitudinal component is greater than a threshold and that is included in an audio signal are selected as third channels. For example, if a longitudinal component of an audio signal with the channel 10 and the channel 16 is greater than the threshold, the two channels, namely, the channel 10 and the channel 16, are selected as third channels, as shown in “sub-combination 2” and “sub-combination 3” in Table 1.

In a possible manner, the decoder side and the encoder side pre-agree on a specific encoding scheme to be used for encoding (or a specific decoding scheme to be used for decoding) of each channel in one frame of scene audio signal.

In a possible manner, the decoder side and the encoder side do not pre-agree on a specific encoding scheme to be used for encoding (or a specific decoding scheme to be used for decoding) of each channel in one frame of scene audio signal. In this case, the encoder may encode a fourth preset identifier. The fourth preset identifier may indicate an encoding scheme corresponding to each channel. Optionally, the encoder side may not need to encode the fourth preset identifier. In this way, after the fourth preset identifier is transmitted to the decoder side, the decoder side performs decoding.

FIG. 5 is a diagram of an example scene audio decoding process. The embodiment in FIG. 5 is a decoding process corresponding to the encoding process in the embodiment in FIG. 4A.

S501: Receive a bitstream.

S502: Based on the bitstream, decode C1 first channels based on a first decoding scheme, decode C2 second channels based on a second decoding scheme, and decode C3 third channels based on a third decoding scheme, to obtain one frame of reconstructed scene audio signal.

For example, the reconstructed scene audio signal may include a reconstructed audio signal with C channels. For example, for one frame of reconstructed scene audio signal, it may be determined that in C channels included in the frame of reconstructed scene audio signal, C1 first channels are decoded based on the first decoding scheme, C2 second channels are decoded based on the second decoding scheme, and C3 third channels are decoded based on the third decoding scheme. C is equal to a sum of C1, C2, and C3, C, C1, C2, and C3 are positive integers, and the first channel, the second channel, and the third channel are different channels.

Then, based on the bitstream, the C1 first channels are decoded based on the first decoding scheme, the C2 second channels are decoded based on the second decoding scheme, and the C3 third channels are decoded based on the third decoding scheme, to obtain a bitstream of the frame of scene audio signal.

For example, based on the bitstream, a process of decoding the C1 first channels based on the first decoding scheme may be: parsing the bitstream, to determine encoded data corresponding to an audio signal with the C1 first channels; and then performing operations such as entropy decoding, dequantization, bit allocation, post-processing, and time-frequency transform on the encoded data corresponding to the audio signal with the C1 first channels, to obtain a reconstructed audio signal with the C1 first channels.

For example, based on the bitstream, a process of decoding the C2 second channels based on the second decoding scheme may include S21 to S24. C1 is equal to (M+1).

S21: Determine a first virtual speaker coefficient corresponding to a target virtual speaker based on attribute information of the target virtual speaker.

For example, an encoder side may write M into a first bitstream, and further, M may be obtained from the first bitstream through decoding (certainly, the encoder side and a decoder side may also pre-agree on M, and this is not limited in the present disclosure). For example, when the attribute information of the target virtual speaker is location information, the location information of the target virtual speaker may be substituted into Formula (3), and m in Formula (3) is equal to M, so that the first virtual speaker coefficient corresponding to the target virtual speaker may be obtained. The first virtual speaker coefficient includes (M+1)² virtual speaker coefficients, and the (M+1)² virtual speaker coefficients correspond to the C1 first channels.

For example, when the attribute information of the target virtual speaker is a location index of the location information, the location information of the target virtual speaker may be determined based on a relationship between location information and a location index; and then the first virtual speaker coefficient is determined in the foregoing manner. This is not described herein again.

For example, when the attribute information of the target virtual speaker is a virtual speaker index, the location information of the target virtual speaker may be determined based on a relationship between location information and a virtual speaker index; and then the first virtual speaker coefficient is determined in the foregoing manner. This is not described herein again.

For example, when the attribute information of the target virtual speaker is a virtual speaker coefficient, it can be learned from the foregoing descriptions that a group of virtual speaker coefficients corresponding to the target virtual speaker include C virtual speaker coefficients. In this case, (M+1)² virtual speaker coefficients corresponding to (M+1)² channels included in the reconstructed audio signal with the C1 first channels may be selected as the first virtual speaker coefficient.

S22: Generate a virtual speaker signal based on the reconstructed audio signal with the C1 first channels and the first virtual speaker coefficient.

For example, the virtual speaker signal may be generated based on the reconstructed audio signal with the C1 first channels and the first virtual speaker coefficient.

For example, it is assumed that a matrix A whose size is (Y1× P) represents the first virtual speaker coefficient of the target virtual speaker. Herein, Y1 (Y1 is a positive integer) is a quantity of target virtual speakers, and P is a channel quantity (M+1)² of an audio signal included in the reconstructed audio signal with the C1 first channels. In addition, a matrix X whose size is (Lx P) represents the reconstructed audio signal with the C1 first channels. L is a quantity of sampling points of the reconstructed audio signal with the C1 first channels. A theoretical optimal solution w is obtained in a least square method, and w represents the virtual speaker signal, as shown in Formula (9).

$$w = {A}^{- 1} X \qquad ( 9 )$$

A matrix A⁻¹ is an inverse matrix of the matrix A.

S23: Determine a second virtual speaker coefficient corresponding to the target virtual speaker based on the attribute information of the target virtual speaker.

For example, it may be determined, based on an expected order quantity N of the reconstructed scene audio signal, that m in formula (3) is equal to N. Then, when the attribute information of the target virtual speaker is the location information, the location information of the target virtual speaker may be substituted into Formula (3), and m in Formula (3) is equal to N, so that the second virtual speaker coefficient may be obtained. The second virtual speaker coefficient includes C virtual speaker coefficients, and the C virtual speaker coefficients correspond to the C channels in the reconstructed scene audio signal.

For example, when the attribute information of the target virtual speaker is a location index of the location information, the location information of the target virtual speaker may be determined based on a relationship between location information and a location index; and then the first virtual speaker coefficient is determined in the foregoing manner. This is not described herein again.

For example, when the attribute information of the target virtual speaker is a virtual speaker index, the location information of the target virtual speaker may be determined based on a relationship between location information and a virtual speaker index; and then the first virtual speaker coefficient is determined in the foregoing manner. This is not described herein again.

For example, when the attribute information of the target virtual speaker is the virtual speaker coefficient, the attribute information of the target virtual speaker may be directly used as the second virtual speaker coefficient.

S24: Obtain a reconstructed audio signal with the C2 second channels based on the virtual speaker signal and the second virtual speaker coefficient.

For example, it is assumed that the matrix A whose size is (Y1x C) represents the second virtual speaker coefficient. Y1 is the quantity of target virtual speakers, and C is the channel quantity of the reconstructed scene audio signal. In addition, the matrix B whose size is (L x Y1) represents the virtual speaker signal. L is a quantity of sampling points of the reconstructed scene audio signal. In this case, the reconstructed scene audio signal may be represented by H, as shown in Formula (10).

$$H = B A \qquad ( 10 )$$

Then, the reconstructed audio signal with the C2 second channels may be selected from the reconstructed scene audio signal.

In a possible manner, in an encoding process, feature information corresponding to the C2 second channels in the scene audio signal may be further extracted, and encoded and sent to the decoder side. After receiving the bitstream, the decoder side may compensate the reconstructed audio signal with the C2 second channels based on the feature information, so that audio quality of the reconstructed audio signal with the C2 second channels in the reconstructed scene audio signal can be improved.

For example, gain information Gain(i) corresponding to the C2 second channels in the scene audio signal may be calculated with reference to Formula (11):

$$Gain ( i ) = E ( i ) / E ( 1 ) \qquad ( 11 )$$

Herein, i is a channel number of the C2 second channels, E(i) is energy of an i^{th} channel, and E(1) is energy of an audio signal with C channels in the scene audio signal.

For example, when the feature information is gain information, compensation may be performed with reference to Formula (12):

$$E ( i ) = Gain ( i ) * E ( 1 ) \qquad ( 12 )$$

Herein, i is a channel number of the C2 second channels, E(i) is energy of an i^{th} channel, E(1) is energy of a reconstructed audio signal with C channels in the reconstructed scene audio signal, and Gain(i) is gain information corresponding to the C2 second channels in the scene audio signal.

In a possible manner, a process of decoding the C3 third channels based on the bitstream and the third decoding scheme may be: processing a reconstructed audio signal with one or more channels in the C1 first channels by using an all-pass filter, to obtain a reconstructed audio signal with the C3 third channels.

For example, Table 1 is pre-synchronized between the decoder side and the encoder side, and the corresponding decoder side stores Table 3 corresponding to Table 1.

TABLE 3

| | | | | | |
|---|---|---|---|---|---|
| Channel | Sub-combination 1 | Sub-combination 2 | Sub-combination 3 | . . . | Sub-combination r |

| | | | |
|---|---|---|---|
| 1 | Direct | Direct | Direct |
| | decoding scheme | decoding scheme | decoding scheme |
| 2 | De-correlation | Direct | Direct |
| | decoding scheme | decoding scheme | decoding scheme |
| 3 | De-correlation | Direct | Direct |
| | decoding scheme | decoding scheme | decoding scheme |
| 4 | De-correlation | Direct | Direct |
| | decoding scheme | decoding scheme | decoding scheme |
| 5 | De-correlation | Direct | Direct |
| | decoding scheme | decoding scheme | decoding scheme |
| 6 | De-correlation | Spatial | Direct |
| | decoding scheme | decoding scheme | decoding scheme |
| 7 | De-correlation | Direct | Direct |
| | decoding scheme | decoding scheme | decoding scheme |
| 8 | De-correlation | Direct | Direct |
| | decoding scheme | decoding scheme | decoding scheme |
| 9 | De-correlation | Direct | Direct |
| | decoding scheme | decoding scheme | decoding scheme |
| 10 | De-correlation | De-correlation | De-correlation |
| | decoding scheme | decoding scheme | decoding scheme |
| 11 | De-correlation | Spatial | Spatial |
| | decoding scheme | decoding scheme | decoding scheme |
| 12 | De-correlation | Spatial | Spatial |
| | decoding scheme | decoding scheme | decoding scheme |
| 13 | De-correlation | Spatial | Spatial |
| | decoding scheme | decoding scheme | decoding scheme |
| 14 | De-correlation | Spatial | Spatial |
| | decoding scheme | decoding scheme | decoding scheme |
| 15 | De-correlation | Spatial | Spatial |
| | decoding scheme | decoding scheme | decoding scheme |
| 16 | De-correlation | De-correlation | De-correlation |
| | decoding scheme | decoding scheme | decoding scheme |

In a possible manner, when the decoder side and the encoder side pre-agree on a specific encoding scheme to be used for encoding (or a specific decoding scheme to be used for decoding) of each channel in one frame of scene audio signal, the decoder side may perform decoding based on a decoding scheme pre-agreed on for each channel in one frame of scene audio signal.

In a possible manner, when the decoder side and the encoder side do not pre-agree on a specific encoding scheme to be used for encoding (or a specific decoding scheme to be used for decoding) of each channel in one frame of scene audio signal, the decoder side may parse out a fourth preset identifier from the bitstream; determine a decoding scheme of each channel based on the fourth preset identifier, and decode each frame of bitstream based on the decoding scheme of each channel, to obtain each frame of reconstructed scene audio signal. That is, the encoder side and the decoder side encode and decode a same channel in a same frame based on a corresponding encoding and decoding scheme.

In a possible manner, the i^{th} frame of scene audio signal is encoded based on a plurality of encoding schemes in a k1^{th} encoding scheme combination; and a j^{th} frame of scene audio signal is encoded based on a plurality of encoding schemes in a k2th encoding scheme combination. Herein, i and j are positive integers between 1 and X, i is unequal to j, k1 and k2 are positive integers, and k1 is unequal to k2. That is, different frames of scene audio signals are encoded based on a plurality of encoding scheme combinations in different types of encoding scheme combinations.

Correspondingly, after receiving the bitstream, the decoder side decodes the i^{th} frame of bitstream in a plurality of decoding schemes in a k1^{th} decoding scheme combination, to obtain an i^{th} frame of reconstructed scene audio signal; and decodes a j^{th} frame of bitstream in a plurality of decoding schemes in a k2^{th} decoding scheme combination, to obtain a j^{th} frame of reconstructed scene audio signal.

FIG. 6 is a diagram of an example scene audio encoding process. In the embodiment in FIG. 6, a plurality of bands of a same channel in one frame are encoded based on a plurality of encoding schemes in an encoding scheme combination.

S601: Obtain a scene audio signal, where the scene audio signal includes an audio signal with C channels, and an audio signal with one channel has Y bands.

For example, an audio signal with each channel in one frame of scene audio signal may be divided into Y bands. Y may be set according to a requirement. This is not limited in the present disclosure.

For example, Y=2. To be specific, the audio signal with one channel may include a band 1 and a band 2. A frequency of the band 1 is less than a first frequency threshold, and a frequency of the band 2 is greater than the first frequency threshold.

For example, Y=3. To be specific, the audio signal with one channel may include a band 1, a band 2, and a band 3. A frequency of the band 1 is less than a first frequency threshold, a frequency of the band 2 is greater than the first frequency threshold and less than a second frequency threshold, and a frequency of the band 3 is greater than the second frequency threshold.

It should be noted that for different channels, a quantity Y of bands may be different, and thresholds used for division into bands may also be different. This is not limited in the present disclosure. The first frequency threshold and the second frequency threshold may be set according to a requirement.

S602: Encode Y bands of one channel in the scene audio signal based on a plurality of encoding schemes in an encoding scheme combination.

The following provides descriptions by using one channel as an example.

For example, when Y=2 and the encoding scheme combination is a combination of a first encoding scheme and a third encoding scheme, an audio signal of a band 1 of the channel may be encoded based on the first encoding scheme, and an audio signal of a band 2 of the channel may be encoded based on the third encoding scheme, as shown in a sub-combination 1 in Table 4. Alternatively, an audio signal of a band 1 of the channel is encoded based on the third encoding scheme, and an audio signal of a band 2 of the channel is encoded based on the first encoding scheme.

For example, when Y=2 and the encoding scheme combination is a combination of a first encoding scheme, a second encoding scheme, and a third encoding scheme, an audio signal of a band 1 of the channel may be encoded based on the first encoding scheme, and an audio signal of a band 2 of the channel may be encoded based on the second encoding scheme, as shown in a sub-combination 2 in Table 4. Alternatively, an audio signal of a band 1 of the channel is encoded based on the second encoding scheme, and an audio signal of a band 2 of the channel is encoded based on the third encoding scheme. Alternatively, an audio signal of a band 1 of the channel is encoded based on the first encoding scheme, and an audio signal of a band 2 of the channel is encoded based on the third encoding scheme.

For example, when Y=3 and the encoding scheme combination is a combination of a first encoding scheme and a third encoding scheme, an audio signal of a band 1 and an audio signal of a band 2 of the channel may be encoded based on the first encoding scheme, and an audio signal of a band 3 of the channel may be encoded based on the third encoding scheme, as shown in a sub-combination 3 in Table 4. Alternatively, an audio signal of a band 1 and an audio signal of a band 3 of the channel are encoded based on the first encoding scheme, and an audio signal of a band 2 of the channel is encoded based on the third encoding scheme. Alternatively, an audio signal of a band 1 and an audio signal of a band 2 of the channel are encoded based on the third encoding scheme, and an audio signal of a band 3 of the channel is encoded based on the first encoding scheme; or the like.

For example, when Y=3 and the encoding scheme combination is a combination of a first encoding scheme, a second encoding scheme, and a third encoding scheme, an audio signal of a band 1 of the channel may be encoded based on the first encoding scheme, an audio signal of a band 2 of the channel may be encoded based on the second encoding scheme, and an audio signal of a band 3 of the channel may be encoded based on the third encoding scheme, as shown in a sub-combination 4 in Table 4. Alternatively, an audio signal of a band 1 of the channel may be encoded based on the second encoding scheme, an audio signal of a band 2 of the channel may be encoded based on the first encoding scheme, and an audio signal of a band 3 of the channel may be encoded based on the third encoding scheme; or the like.

In this way, w (w is a positive integer) sub-combinations may be generated for one channel, and different encoding scheme combinations may include one or more sub-combinations.

TABLE 4

| | Sub- | Sub- | Sub- | Sub- | | Sub- |
|---|---|---|---|---|---|---|
| | combination | combination | combination | combination | | combination |
| Band | 1 | 2 | 3 | 4 | . . . | w |

| | | | | |
|---|---|---|---|---|
| 1 | Direct | Direct | Direct | Direct |
| | encoding | encoding | encoding | encoding |
| | scheme | scheme | scheme | scheme |
| 2 | De- | Spatial | Direct | Spatial |
| | correlation | encoding | encoding | encoding |
| | encoding | scheme | scheme | scheme |
| | scheme | | | |
| 3 | | | De- | De- |
| | | | correlation | correlation |
| | | | encoding | encoding |
| | | | scheme | scheme |

In a possible manner, a decoder side and an encoder side may pre-agree on a specific encoding scheme to be used for encoding (or a specific decoding scheme to be used for decoding) of Y bands of one channel in one frame of scene audio signal.

In a possible manner, the decoder side and the encoder side do not pre-agree on a specific encoding scheme to be used for encoding (or a specific decoding scheme to be used for decoding) of Y bands of one channel in one frame of scene audio signal. In this case, the encoder may encode a fifth preset identifier. The fifth preset identifier may indicate an encoding scheme corresponding to each band of each channel. Optionally, the encoder side may not need to encode the fifth preset identifier. In this way, after the fifth preset identifier is transmitted to the decoder side, the decoder side performs decoding.

It should be understood that, a plurality of bands of different channels in one frame of scene audio signal may be encoded based on a plurality of encoding schemes in different types of encoding scheme combinations. This is not limited in the present disclosure.

FIG. 7 is a diagram of an example scene audio decoding process. The embodiment in FIG. 7 is a decoding process corresponding to the encoding process in the embodiment in FIG. 6.

S701: Receive a bitstream.

For example, a reconstructed audio signal with each channel in one frame of reconstructed scene audio signal may be divided into Y bands. Y may be set according to a requirement. This is not limited in the present disclosure.

For example, Y=2. To be specific, a reconstructed audio signal with one channel may include a band 1 and a band 2. A frequency of the band 1 is less than a first frequency threshold, and a frequency of the band 2 is greater than the first frequency threshold.

For example, Y=3. To be specific, a reconstructed audio signal with one channel may include a band 1, a band 2, and a band 3. A frequency of the band 1 is less than a first frequency threshold, a frequency of the band 2 is greater than the first frequency threshold and less than a second frequency threshold, and a frequency of the band 3 is greater than the second frequency threshold.

It should be noted that for different channels, a quantity Y of bands may be different, and thresholds used for division into bands may also be different. This is not limited in the present disclosure. The first frequency threshold and the first frequency threshold may be set according to a requirement.

It should be understood that a manner of dividing each channel into bands by the decoder side is the same as a manner of dividing each channel into bands by the encoder side.

S702: For Y bands of one channel in one frame, decode one frame of bitstream based on a plurality of decoding schemes in a decoding scheme combination, to obtain one frame of reconstructed scene audio signal.

The following provides descriptions by using one channel as an example.

For example, when Y=2 and the decoding scheme combination is a combination of a first decoding scheme and a third decoding scheme, an audio signal of a band 1 of the channel may be decoded based on the first decoding scheme, and an audio signal of a band 2 of the channel may be decoded based on the third decoding scheme, as shown in a sub-combination 1 in Table 5. Alternatively, an audio signal of a band 1 of the channel is decoded based on the third decoding scheme, and an audio signal of a band 2 of the channel is decoded based on the first decoding scheme.

For example, when Y=2 and the decoding scheme combination is a combination of a first decoding scheme, a second decoding scheme, and a third decoding scheme, an audio signal of a band 1 of the channel may be decoded based on the first decoding scheme, and an audio signal of a band 2 of the channel may be decoded based on the second decoding scheme, as shown in a sub-combination 2 in Table 5. Alternatively, an audio signal of a band 1 of the channel is decoded based on the second decoding scheme, and an audio signal of a band 2 of the channel is decoded based on the third decoding scheme. Alternatively, an audio signal of a band 1 of the channel is decoded based on the second decoding scheme, and an audio signal of a band 2 of the channel is decoded based on the third decoding scheme.

For example, when Y=3 and the decoding scheme combination is a combination of a first decoding scheme and a third decoding scheme, an audio signal of a band 1 and an audio signal of a band 2 of the channel may be decoded based on the first decoding scheme, and an audio signal of a band 3 of the channel may be decoded based on the third decoding scheme, as shown in a sub-combination 3 in Table 5. Alternatively, an audio signal of a band 1 and an audio signal of a band 3 of the channel are decoded based on the first decoding scheme, and an audio signal of a band 2 of the channel is decoded based on the third decoding scheme. Alternatively, an audio signal of a band 1 and an audio signal of a band 2 of the channel are decoded based on the third decoding scheme, and an audio signal of a band 3 of the channel is decoded based on the first decoding scheme; or the like.

For example, when Y=3 and the decoding scheme combination is a combination of a first decoding scheme, a second decoding scheme, and a third decoding scheme, an audio signal of a band 1 of the channel may be decoded based on the first decoding scheme, an audio signal of a band 2 of the channel may be decoded based on the second decoding scheme, and an audio signal of a band 3 of the channel may be decoded based on the third decoding scheme, as shown in a sub-combination 4 in Table 5. Alternatively, an audio signal of a band 1 of the channel may be decoded based on the second decoding scheme, an audio signal of a band 2 of the channel may be decoded based on the first decoding scheme, and an audio signal of a band 3 of the channel may be decoded based on the third decoding scheme; or the like.

In this way, w (w is a positive integer) sub-combinations may be generated for one channel, and different decoding scheme combinations may include one or more sub-combinations.

TABLE 5

| | Sub- | Sub- | Sub- | Sub- | | Sub- |
|---|---|---|---|---|---|---|
| | combination | combination | combination | combination | | combination |
| Band | 1 | 2 | 3 | 4 | . . . | w |

| | | | | |
|---|---|---|---|---|
| 1 | Direct | Direct | Direct | Direct |
| | decoding | decoding | decoding | decoding |
| | scheme | scheme | scheme | scheme |
| 2 | De-correlation | Spatial | Direct | Spatial |
| | decoding | decoding | decoding | decoding |
| | scheme | scheme | scheme | scheme |
| 3 | | | De-correlation | De-correlation |
| | | | decoding | decoding |
| | | | scheme | scheme |

In a possible manner, when the decoder side and the encoder side pre-agree on a specific encoding scheme to be used for encoding (or a specific decoding scheme to be used for decoding) of Y bands of one channel in one frame of scene audio signal, the decoder side may decode a corresponding band based on a pre-agreed encoding scheme, to obtain a reconstructed audio signal with the channel.

In a possible manner, when the decoder side and the encoder side do not pre-agree on a specific encoding scheme to be used for encoding (or a specific decoding scheme to be used for decoding) of Y bands of one channel in one frame of scene audio signal, after receiving the bitstream, the decoder side may parse out a fifth preset identifier from the bitstream, and then determine a decoding scheme of each band in the Y frequency bands of each channel based on the fifth preset identifier. Then, the bitstream is decoded based on the decoding scheme determined for the Y bands of each channel based on the fifth preset identifier, to obtain a reconstructed audio signal with the channel.

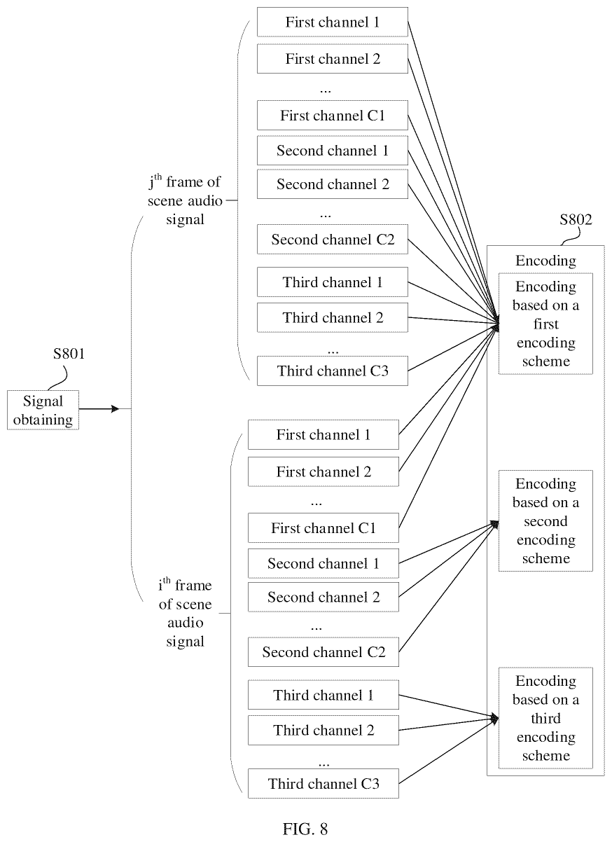

FIG. 8 is a diagram of an example scene audio encoding process. In the embodiment in FIG. 8, a part of frames is encoded based on a plurality of encoding schemes in an encoding scheme combination, and another part of frames are encoded based on a first encoding scheme in the encoding scheme combination.

S801: Obtain a scene audio signal.

S802: Encode an i^{th} frame of scene audio signal based on a plurality of encoding schemes in the encoding scheme combination.

For example, for S802, refer to the foregoing descriptions.

S803: Encode a j^{th} frame of scene audio signal based on the first encoding scheme in the encoding scheme combination.

Herein, i and j are positive integers between 1 and X, i is unequal to j, k1 and k2 are positive integers, and k1 is unequal to k2.

For example, regardless of whether the encoding scheme combination is a combination of the first encoding scheme and a third encoding scheme, or a combination of the first encoding scheme, a second encoding scheme, and a third encoding scheme, the j^{th} frame of scene audio signal is encoded based on the first encoding scheme in the encoding scheme combination.

It should be noted that, in the present disclosure, a quantity of frames of the scene audio signal that are encoded based on the first encoding scheme in the encoding scheme combination, and a quantity of frames of the scene audio signal that are encoded in a plurality of encoding schemes in the encoding scheme combination are not limited. In addition, in the present disclosure, a specific frame that is encoded based on the first encoding scheme in the encoding scheme combination is not limited, and a specific frame that is encoded based on a plurality of encoding schemes in the encoding scheme combination is not limited.

In a possible manner, an encoder side and a decoder side may pre-agree on specific frames that are encoded based on the first encoding scheme in the encoding scheme combination, and pre-agree on specific frames that are encoded based on a plurality of encoding schemes in the encoding scheme combination.

In a possible manner, an encoder side and a decoder side do not pre-agree on an encoding and decoding scheme of each frame. In this case, when the i^{th} frame of scene audio signal is encoded based on a plurality of encoding schemes in the encoding scheme combination, a second preset identifier (the second preset identifier indicates a type of an encoding scheme combination corresponding to each frame) is written into an i^{th} frame of bitstream; and when the j^{th} frame of scene audio signal is encoded based on the first encoding scheme in the encoding scheme combination, a sixth preset identifier is written into a j^{th} frame of bitstream. The sixth preset identifier indicates that a current frame is encoded based on the first encoding scheme.

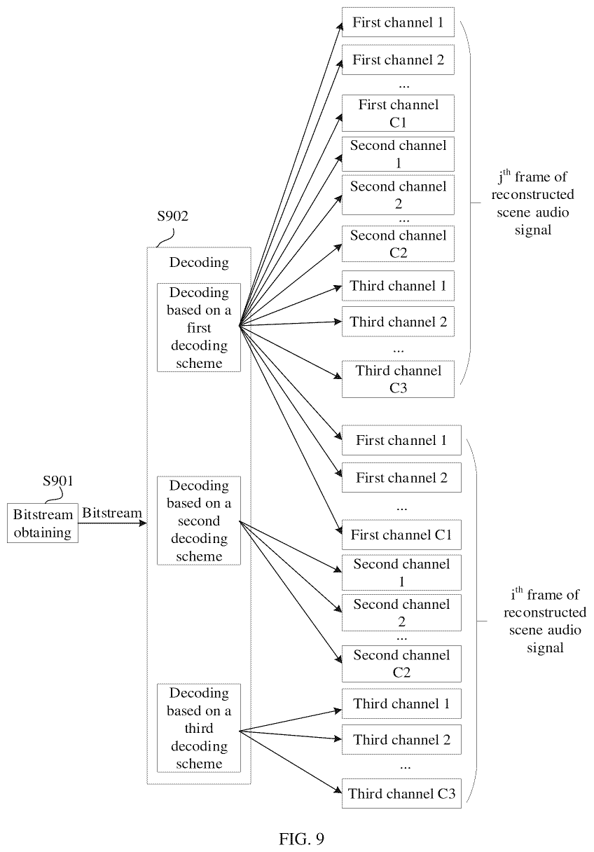

FIG. 9 is a diagram of an example scene audio decoding process. FIG. 9 shows a decoding process corresponding to the encoding process in FIG. 8.

S901: Receive a bitstream.

S902: Decode an i^{th} frame of bitstream based on a plurality of decoding schemes in a decoding scheme combination, to obtain an i^{th} frame of reconstructed scene audio signal.

For example, for S902, refer to the foregoing descriptions.

S903: Decode a j^{th} frame of bitstream based on a decoding scheme in the decoding scheme combination, to obtain a j^{th} frame of reconstructed scene audio signal.

Herein, i and j are positive integers between 1 and X, i is unequal to j, k1 and k2 are positive integers, and k1 is unequal to k2.

For example, regardless of whether the decoding scheme combination is a combination of a first decoding scheme and a third decoding scheme, or a combination of a first decoding scheme, a second decoding scheme, and a third decoding scheme, the j^{th} frame of scene audio signal is decoded based on the first decoding scheme in the decoding scheme combination.

It should be noted that, in the present disclosure, a quantity of frames of the scene audio signal that are decoded based on the first decoding scheme in the decoding scheme combination, and a quantity of frames of the scene audio signal that are decoded in a plurality of decoding schemes in the decoding scheme combination are not limited.

In a possible manner, when a decoder side and an encoder side pre-agree on specific frames that are encoded based on a plurality of schemes in an encoding scheme combination, and specific frames that are encoded in a first encoding scheme in the encoding scheme combination, the decoder side may decode the bitstream in a pre-agreed encoding scheme, to obtain a reconstructed scene audio signal.

In a possible manner, when a decoder side and an encoder side do not pre-agree on specific frames that are encoded in a plurality of schemes in an encoding scheme combination, and specific frames that are encoded based on a first encoding scheme in the encoding scheme combination, after receiving the bitstream, when a second preset identifier is parsed out from a specific frame of bitstream, the decoder side may decode the frame of bitstream based on a plurality of decoding schemes in a decoding scheme combination corresponding to the second preset identifier, to obtain one frame of reconstructed scene audio signal. When a sixth preset identifier is parsed out from a specific frame of bitstream, the frame of bitstream may be decoded based on the first decoding scheme, to obtain one frame of reconstructed scene audio signal.

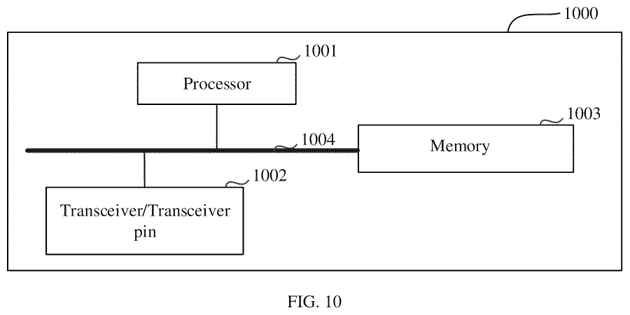

In an example, FIG. 10 is a block diagram of an apparatus 1000 according to an embodiment of the present disclosure. The apparatus 1000 may include a processor 1001 and a transceiver/transceiver pin 1002, and optionally further includes a memory 1003.

Components of the apparatus 1000 are coupled together through a bus 1004. In addition to a data bus, the bus 1004 further includes a power bus, a control bus, and a status signal bus. However, for clarity of description, various buses are referred to as the bus 1004 in the figure.

Optionally, the memory 1003 may be configured to store instructions in the foregoing method embodiments. The processor 1001 may be configured to execute the instructions in the memory 1003, control a receive pin to receive a signal, and control a transmit pin to send a signal. When the processor 1001 is configured to execute the instructions in the memory 1003, the apparatus is enabled to perform the foregoing related method steps to implement the method in the foregoing embodiments.

The apparatus 1000 may be the electronic device in the foregoing method embodiments or a chip of the electronic device.

The electronic device may be a terminal device, or may be a server.

All related content of the steps in the foregoing method embodiments may be cited in function descriptions of the corresponding functional modules.

An embodiment of the present disclosure further provides a chip, including one or more interface circuits and one or more processors. The one or more processors receive or send data through the one or more interface circuits. When the one or more processors execute computer instructions, the electronic device is enabled to perform the foregoing related method steps to implement the method in the foregoing embodiments. The interface circuit is a transceiver/transmit/receive pin 1002.

An embodiment further provides a computer-readable storage medium. The computer-readable storage medium stores computer instructions. When the computer instructions are run on an electronic device, the electronic device is enabled to perform the foregoing related method steps, to implement the methods in the foregoing embodiments.

An embodiment further provides a computer program product. The computer program product includes computer instructions, and when the computer instructions are executed by a computer or a processor, the computer is enabled to perform the foregoing related steps to implement the method in the foregoing embodiments.

In addition, an embodiment of the present disclosure further provides an apparatus. The apparatus may be a chip, a component, or a module. The apparatus may include a processor and a memory that are connected. The memory is configured to store computer-executable instructions. When the apparatus runs, the processor may execute the computer-executable instructions stored in the memory, to enable the chip to perform the method in the foregoing method embodiments.

The electronic device, the computer-readable storage medium, the computer program product, or the chip provided in embodiments is configured to perform the corresponding method provided above. Therefore, for beneficial effect that can be achieved, refer to the beneficial effect in the corresponding method provided above.

Based on the descriptions about the foregoing implementations, a person skilled in the art may understand that, for a purpose of convenient and brief description, division into the foregoing functional modules is used as an example for illustration. In actual application, the foregoing functions may be allocated to different functional modules and implemented according to requirements. In other words, an inner structure of an apparatus is divided into different functional modules to implement all or some of the functions described above.

In the several embodiments provided in the present disclosure, it should be understood that the disclosed apparatus and method may be implemented in another manner. For example, the described apparatus embodiment is merely an example. For example, division into modules or units is merely logical functional division and may be other division in actual implementations. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate, and parts displayed as units may be one or more physical units, may be located in one place, or may be distributed on different places. Some or all of the units may be selected according to an actual requirement, to achieve the objectives of the solutions of embodiments.

In addition, functional units in embodiments of the present disclosure may be integrated into one processing unit, each of the units may exist alone physically, or two or more units may be integrated into one unit. The integrated unit may be implemented in a form of hardware, or may be implemented in a form of a software functional unit.

Any content in embodiments of the present disclosure and any content in a same embodiment can be freely combined. Any combination of the foregoing content falls within the scope of the present disclosure.

When the integrated unit is implemented in the form of a software functional unit and sold or used as an independent product, the integrated unit may be stored in a readable storage medium. Based on such an understanding, the technical solutions of embodiments of this application may be implemented in a form of a software product. The software product is stored in a storage medium and includes several instructions for instructing a device (which may be a single-chip microcomputer, a chip, or the like) or a processor to perform all or some of the steps of the methods described in embodiments of the present disclosure. The storage medium includes various media that can store program code, for example, a Universal Serial Bus (USB) flash drive, a removable hard disk drive, a read-only memory (ROM), a random-access memory (RAM), a magnetic disk, or an optical disc.

The foregoing describes embodiments of the present disclosure with reference to the accompanying drawings. However, the present disclosure is not limited to the foregoing specific implementations. The foregoing specific implementations are merely examples instead of limitations. Inspired by the present disclosure, a person of ordinary skill in the art may further make modifications without departing from the purposes of the present disclosure and the protection scope of the claims, and all the modifications shall fall within the protection of this application.

Methods or algorithm steps described in combination with the content disclosed in this embodiment of the present disclosure may be implemented by hardware, or may be implemented by a processor by executing a software instruction. The software instruction may include a corresponding software module. The software module may be stored in RAM, a flash memory, a ROM, an erasable programmable read-only memory (EPROM), an electrically erasable programmable read-only memory (EEPROM), a register, a hard disk, a removable hard disk, a compact disc read-only memory (CD-ROM), or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an ASIC.

A person skilled in the art should be aware that in the foregoing one or more examples, functions described in embodiments of the present disclosure may be implemented by hardware, software, firmware, or any combination thereof. When the functions are implemented by software, the foregoing functions may be stored in a computer-readable medium or transmitted as one or more instructions or code in a computer-readable medium. The computer-readable medium includes a computer-readable storage medium and a communication medium, where the communication medium includes any medium that enables a computer program to be transmitted from one place to another. The storage medium may be any available medium accessible to a general-purpose or a dedicated computer.

What is claimed is:

1. A method comprising:
receiving a bitstream; and
decoding the bitstream based on a decoding scheme combination to obtain a reconstructed scene audio signal,
wherein the decoding scheme combination comprises at least one of a first combination or a second combination,
wherein the first combination comprises a first decoding scheme, a second decoding scheme, and a third decoding scheme,
wherein the second combination comprises the first decoding scheme and the third decoding scheme,
wherein the first decoding scheme decodes encoded data that are based on encoding a signal,
wherein the second decoding scheme is a spatial decoding scheme, and
wherein the third decoding scheme is different than the first decoding scheme and the second decoding scheme.

2. The method of claim 1, wherein decoding the bitstream comprises obtaining attribute information of a target virtual speaker, and wherein the spatial decoding scheme comprises performing reconstruction based on the attribute information.

3. The method of claim 1, wherein the third decoding scheme comprises a channel copy decoding scheme, and wherein the channel copy decoding scheme is a de-correlation decoding scheme.

4. The method of claim 1, wherein decoding the bitstream comprises decoding an encoded frame in the bitstream based on a plurality of decoding schemes in the decoding scheme combination to obtain a decoded frame of the reconstructed scene audio signal.

5. The method of claim 4, wherein the decoded frame comprises a reconstructed audio signal with C channels, wherein when the decoding scheme combination is the first combination, decoding the encoded frame comprises decoding, based on the encoded frame, C1 first channels based on the first decoding scheme, C2 second channels based on the second decoding scheme, and C3 third channels based on the third decoding scheme to obtain the decoded frame, wherein C is equal to a sum of C1, C2, and C3, and wherein C, C1, C2, and C3 are positive integers.

6. The method of claim 5, wherein the reconstructed scene audio signal is an N-order higher-order ambisonics (HOA) signal, wherein the C1 first channels are C1 channels comprised in a 0^{th} order to an M^{th} order of the N-order HOA signal, wherein M is an integer less than N, wherein C is equal to a square of (N+1), and wherein C1 is less than or equal to a square of (M+1), wherein the C2 second channels comprise C4 channels comprised in the 0^{th} order to the M^{th} order of the N-order HOA signal, and C5 channels in the N-order HOA signal other than channels comprised in the 0^{th} order to the M^{th} order, wherein the C3 third channels comprise C6 channels comprised in the 0^{th} order to the M^{th} order of the N-order HOA signal, and C7 channels in the N-order HOA signal other than the channels comprised in the 0^{th} order to the M^{th} order, wherein C2 is equal to C4 plus C5, wherein C3 is equal to C6 plus C7, wherein a square of (M+1) is equal to C1 plus C4 and C6, and wherein C4, C5, C6, and C7 are integers.

7. The method of claim 5, further comprising parsing the bitstream to obtain a first preset identifier, wherein the third decoding scheme corresponds to the first preset identifier and is a time-domain de-correlation decoding scheme or a frequency-domain de-correlation decoding scheme.

8. The method of claim 5, wherein when the decoding scheme is the first combination, the method further comprises:
parsing the bitstream to obtain feature information corresponding to the C2 second channels; and
compensating the reconstructed audio signal with the C2 second channels in the reconstructed scene audio signal based on the feature information.

9. The method of claim 4, wherein the decoded frame comprises a first reconstructed audio signal and a second reconstructed audio signal, wherein the first reconstructed audio signal comprises C channels, wherein the second reconstructed audio signal comprises one channel having Y bands, wherein C and Y are positive integers, and wherein decoding the encoded frame comprises decoding, for the Y bands of the one channel in the decoded frame, the encoded frame to obtain the decoded frame.

10. The method of claim 1, wherein the bitstream comprises X frames, wherein the X frames comprise a first i^{th} frame and a first j^{th} frame, wherein X is a positive integer, wherein i and j are different integers between 1 and X, and wherein decoding the bitstream comprises:
decoding the first i^{th} frame based on a plurality of decoding schemes in the decoding scheme combination to obtain a second i^{th} frame of the reconstructed scene audio signal; and
decoding the first j^{th} frame based on the first decoding scheme in the decoding scheme combination to obtain a second j^{th} frame of the reconstructed scene audio signal.

11. The method of claim 1, wherein the bitstream comprises X frames, wherein the X frames comprise a first i^{th} frame and a first j^{th} frame, wherein X is a positive integer, wherein i and j are different integers between 1 and X, and wherein decoding the bitstream comprises:
decoding the first i^{th} frame based on a plurality of decoding schemes in a k1^{th} decoding scheme combination to obtain a second i^{th} frame of the reconstructed scene audio signal; and
decoding the first j^{th} frame based on the plurality of decoding schemes in a k2^{th} decoding scheme combination to obtain a second j^{th} frame of the reconstructed scene audio signal.

12. The method of claim 1, further comprising parsing out a preset identifier from the bitstream, wherein the decoding scheme combination corresponds to the preset identifier.

13. An electronic device comprising:
a memory configured to store instructions; and
one or more processors coupled to the memory and configured to execute the instructions to cause the electronic device to:
receive a bitstream; and
decode the bitstream based on a decoding scheme combination to obtain a reconstructed scene audio signal,
wherein the decoding scheme combination comprises at least one of a first combination or a second combination,
wherein the first combination comprises a first decoding scheme, a second decoding scheme, and a third decoding scheme,
wherein the second combination comprises the first decoding scheme and the third decoding scheme,
wherein the first decoding scheme decodes encoded data that are based on encoding a signal,
wherein the second decoding scheme is a spatial decoding scheme, and
wherein the third decoding scheme is different than the first decoding scheme and the second decoding scheme.

14. The electronic device of claim 13, wherein the one or more processors are further configured to execute the instructions to further cause the electronic device to decode the bitstream by obtaining attribute information of a target virtual speaker, and wherein the spatial decoding scheme comprises performing reconstruction based on the attribute information.

15. The electronic device of claim 13, wherein the third decoding scheme comprises a channel copy encoding scheme, and wherein the channel copy encoding scheme is a de-correlation encoding scheme.

16. The electronic device of claim 13, wherein the one or more processors are further configured to execute the instructions to further cause the electronic device to decode the bitstream by decoding an encoded frame in the bitstream based on a plurality of decoding schemes in the decoding scheme combination to obtain a decoded frame of the reconstructed scene audio signal.

17. The electronic device of claim 16, wherein the decoded frame comprises a reconstructed audio signal with C channels, wherein when the decoding scheme combination is the first combination, the one or more processors are further configured to execute the instructions to further cause the electronic device to decode, based on the encoded frame, C1 first channels based on the first decoding scheme, C2 second channels based on the second decoding scheme, and C3 third channels based on the third decoding scheme to obtain the decoded frame, wherein C is equal to a sum of C1, C2, and C3, and wherein C, C1, C2, and C3 are positive integers.

18. The electronic device of claim 16, wherein the decoded frame comprises a first reconstructed audio signal and a second reconstructed audio signal, wherein the first reconstructed audio signal comprises C channels, wherein the second reconstructed audio signal comprises one channel has Y bands, wherein C and Y are positive integers, and the one or more processors are further configured to execute the instructions to further cause the electronic device to decode the encoded frame by decoding, for the Y bands of the one channel in the decoded frame, the encoded frame to obtain the decoded frame.

19. A computer program product comprising computer-executable instructions that are stored on a non-transitory computer-readable storage medium and that, when executed by one or more processors, cause an electronic device to:
receive a bitstream; and
decode the bitstream based on a decoding scheme combination, to obtain a reconstructed scene audio signal,
wherein the decoding scheme combination comprises at least one of a first combination or a second combination,
wherein the first combination comprises a first decoding scheme, a second decoding scheme, and a third decoding scheme,
wherein the second combination comprises the first decoding scheme and the third decoding scheme,
wherein the first decoding scheme decodes encoded data that are based on encoding a signal,
wherein the second decoding scheme is a spatial decoding scheme, and
wherein the third decoding scheme is different than the first decoding scheme and the second decoding scheme.

20. The computer program product of claim 19, wherein the one or more processors are further configured to execute the instructions to further cause the electronic device to decode the bitstream by obtaining attribute information of a target virtual speaker, and wherein the spatial decoding scheme comprises performing reconstruction based on the attribute information.
